(19) United States
(12) Patent Application Publication
(10) Pub. No.: US 2024/0035515 A1
(43) Pub. Date: Feb. 1, 2024

(54) BEARING PART AND ROLLING BEARING

(71) Applicant: NTN Corporation, Osaka (JP)

(72) Inventors: Naoki FUJIMURA, Kuwana-shi, Mie (JP); Masahiro YAMADA, Kuwana-shi, Mie (JP); Chikara OHKI, Kuwana-shi, Mie (JP)

(21) Appl. No.: 18/025,379

(22) PCT Filed: Sep. 16, 2021
(86) PCT No.: PCT/JP2021/034141

§ 371 Date: Mar. 8, 2023

(30) Foreign Application Priority Data
Sep. 24, 2020 (JP) 2020-159671
Dec. 15, 2020 (JP) 2020-207596
Mar. 25, 2021 (JP) 2021-052153

(51) Int. Cl. F16C 33/62; F16C 19/06; C21D 9/40; C21D 1/18; C21D 1/74; C23C 8/32

(52) U.S. Cl. CPC F16C 33/62; F16C 19/06; C21D 9/40; C21D 1/18; C21D 1/74; C23C 8/32; C21D 2211/003; C21D 2211/008

(57) ABSTRACT

A bearing part (10) is composed of a steel, and has a quench-hardened layer (11) in a surface of the bearing part. The quench-hardened layer includes a plurality of martensite crystal grains. The plurality of martensite crystal grains are classified into a first group and a second group. A minimum value of crystal grain sizes of the martensite crystal grains belonging to the first group is larger than a maximum value of crystal grain sizes of the martensite crystal grains belonging to the second group. A value obtained by dividing a total area of the martensite crystal grains belonging to the first group by the total area of the plurality of martensite crystal grains is more than or equal to 0.3. A value obtained by dividing, by the total area of the plurality of martensite crystal grains, a total area of the martensite crystal grains belonging to the first group except for a martensite crystal grain that has a minimum crystal grain size and that belongs to the first group is less than 0.3. An average grain size of the martensite crystal grains belonging to the first group is less than or equal to 1.5 μm. The quench-hardened layer (11) further includes a plurality of cementite grains. A number density of cementite grains each having a grain size of more than or equal to 1 μm is more than or equal to 0.025/μm².

### TECHNICAL FIELD

The present invention relates to a bearing part and a rolling bearing.

### BACKGROUND ART

In response to an advance in reducing fuel consumption of a vehicle or the like in recent years, an environment in which a bearing is used has become severe, with the result that a bearing having an excellent wear resistance and an excellent indentation formation resistance has been desired.

In order to improve the wear resistance, it is effective to form fine martensite crystal grains (see Japanese Patent Laying-Open No. 2019-108576). This is due to the following reason: when the martensite crystal grains are fine, plastic deformation resistance of a martensite phase is increased and interface energy of the martensite crystal grains is increased to promote gas adsorption on a worn surface, thereby suppressing severe wear.

On the other hand, in order to improve the indentation formation resistance, it is also effective to form fine martensite crystal grains (see Japanese Patent No 6626918). This is due to the following reason: since the plastic deformation resistance of the martensite phase is also increased as described above, the indentation formation resistance is increased.

As a technique for forming fine martensite crystal grains, Japanese Patent No. 6626918 describes a technique (low-temperature secondary quenching) for performing nitriding-quenching and then performing quenching at a lower temperature than that of the nitriding-quenching.

### CITATION LIST

### Patent Literature

PTL 1: Japanese Patent Laying-Open No. 2019-108576
PTL 2: Japanese Patent No. 6626918

### SUMMARY OF INVENTION

### Technical Problem

However, according to knowledge found by the present inventors, there is room for improvement in forming fine martensite crystal grains in the technique for performing the low-temperature secondary quenching after the nitriding-quenching.

It is a main object of the present invention to provide a bearing part and a rolling bearing each having a high wear resistance and a high indentation formation resistance.

### Solution to Problem

A bearing part according to the present invention is composed of a steel, and includes a quench-hardened layer in a surface of the bearing part. The quench-hardened layer includes a plurality of martensite crystal grains. A ratio of a total area of the plurality of martensite crystal grains in the quench-hardened layer is more than or equal to 70%. The plurality of martensite crystal grains are classified into a first group and a second group. A minimum value of crystal grain sizes of the martensite crystal grains belonging to the first group is larger than a maximum value of crystal grain sizes of the martensite crystal grains belonging to the second group. A value obtained by dividing a total area of the martensite crystal grains belonging to the first group by the total area of the plurality of martensite crystal grains is more than or equal to 0.3. A value obtained by dividing, by the total area of the plurality of martensite crystal grains, a total area of the martensite crystal grains belonging to the first group except for a martensite crystal grain that has a minimum crystal grain size and that belongs to the first group is less than 0.3. An average grain size of the martensite crystal grains belonging to the first group is less than or equal to 1.5 μm. The quench-hardened layer further includes a plurality of cementite grains. A number density of cementite grains each having a grain size of more than or equal to 1 μm is more than or equal to 0.025/μm².

In the bearing part according to the present invention, an average aspect ratio of the martensite crystal grains belonging to the first group may be less than or equal to 3.1.

In the bearing part according to the present invention, a remaining austenite amount in the surface may be more than or equal to 20 volume %.

In the bearing part according to the present invention, the quench-hardened layer may contain nitrogen. An average nitrogen concentration of the quench-hardened layer may be more than or equal to 0.15 mass % between the surface and a position at a distance of 10 μm from the surface.

In the bearing part according to the present invention, a hardness of the quench-hardened layer in the surface may be more than or equal to 730 Hv.

In the bearing part according to the present invention, the steel may be a high carbon chromium bearing steel SUJ2 defined in JIS.

A method for manufacturing a bearing part according to the present invention includes: a step of preparing a formed body composed of a high carbon chromium bearing steel; a carbonitriding step of heating the formed body in a carbonitriding atmosphere to a first temperature that is more than or equal to an A₁ transformation point of steel, and then cooling the formed body to a temperature that is less than or equal to an Ms transformation point of steel; a first tempering step of holding the formed body to a second temperature that is more than or equal to 180° C. and less than the A₁ transformation point after the carbonitriding step; a quenching step of heating the formed body again to a third temperature that is more than or equal to the A₁ transformation point and less than the first temperature, and then cooling the formed body to a temperature that is less than or equal to the Ms transformation point of steel; and a second tempering step of holding the formed body at a fourth temperature that is less than the A₁ transformation point after the quenching step.

In the method for manufacturing the bearing part according to the present invention, the second temperature is preferably more than or equal to 250° C. and less than or equal to 350° C.

### Advantageous Effects of Invention

According to the present invention, there can be provided a bearing part and a rolling bearing each having a high wear resistance and a high indentation formation resistance.

### BRIEF DESCRIPTION OF DRAWINGS

FIG. 1 is a top view of an inner ring 10 according to a first embodiment.

FIG. 2 is a cross sectional view taken along 11-11 of FIG. 1.

FIG. 3 is an enlarged view at III in FIG. 2.

FIG. 4 is a flowchart showing a method for manufacturing inner ring 10.

FIG. 5 shows an EBSD image at a cross section of a sample 1.

FIG. 6 shows an EBSD image at a cross section of a sample 2.

FIG. 7 shows an EBSD image at a cross section of a sample 3.

FIG. 8 shows an EBSD image at a cross section of a sample 4.

FIG. 9 shows an EBSD image at a cross section of a sample 5.

FIG. 10 is a graph showing a relation between a maximum contact pressure and an indentation depth.

FIG. 11 is a graph showing a relation between an average grain size of martensite crystal grains and a static load capacity.

FIG. 12 is a graph showing a relation between an average aspect ratio of the martensite crystal grains and the static load capacity.

FIG. 13 is a flowchart showing a method for manufacturing a bearing part according to a second embodiment.

FIG. 14 is a graph showing a heat pattern in the method for manufacturing the bearing part according to the second embodiment.

FIG. 15 shows an EBSD image at a raceway surface of a sample 11.

FIG. 16 shows an EBSD image at a raceway surface of a sample 12.

FIG. 17 shows an EBSD image at a raceway surface of a sample 13.

FIG. 18 shows an EBSD image at a raceway surface of a sample 14.

FIG. 19 is a graph showing an average grain size of martensite crystal grains belonging to a first group and an average grain size of martensite crystal grains belonging to a third group in the case of each of samples 11 to 14.

FIG. 20 is a graph showing an average aspect ratio of the martensite crystal grains belonging to the first group and an average aspect ratio of the martensite crystal grains belonging to the third group in the case of each of samples 11 to 14.

FIG. 21 is a graph showing an average grain size of cementite grains belonging to a fifth group and an average grain size of cementite grains belonging to a seventh group in the case of each of samples 11 to 14.

FIG. 22 is a graph showing a number density of the cementite grains belonging to the fifth group and a number density of the cementite grains belonging to the seventh group in the case of each of samples 11 to 14.

FIG. 23 is a graph showing a relation between a maximum contact pressure (unit: GPa) and an indentation depth (unit: mm) in an indentation resistance test in the case of each of samples 11 to 14.

### DESCRIPTION OF EMBODIMENTS

Embodiments of the present invention will be described in detail with reference to figures. It should be noted that in the figures described below, the same or corresponding parts are denoted by the same reference characters and the same explanation will not be described repeatedly.

(Configuration of Bearing Part According to First Embodiment)

The following describes a configuration of a bearing part according to a first embodiment. It should be noted that in the description below, an inner ring 10 (ring member) of a rolling bearing will be illustratively described as an exemplary bearing part according to the embodiment; however, the bearing part according to the embodiment is not limited to this. Specifically, the bearing part according to the embodiment may be an outer ring (ring member) of a rolling bearing or a rolling element of the rolling bearing.

Inner ring 10 is composed of a steel. The steel of inner ring 10 is a high carbon chromium bearing steel defined in JIS (JIS G 4805: 2008). The steel of inner ring 10 is preferably SUJ2 defined in JIS.

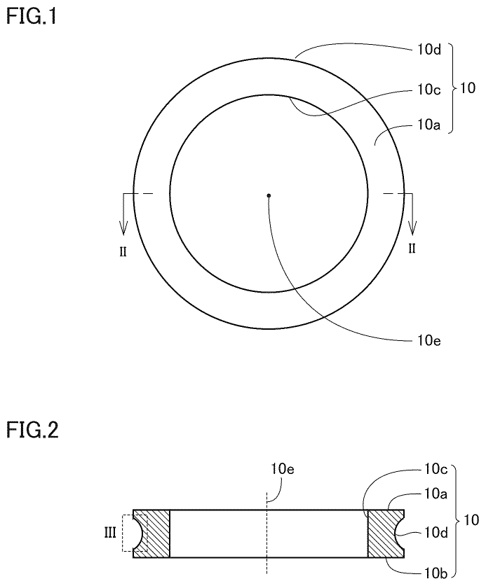

FIG. 1 is a top view of inner ring 10. FIG. 2 is a cross sectional view along II-II of FIG. 1. As shown in FIG. 1 and FIG. 2, inner ring 10 has a ring shape. Inner ring 10 has an upper surface 10a, a bottom surface 10b, an inner circumferential surface 10c, an outer circumferential surface 10d, and a center axis 10e.

Upper surface 10a and bottom surface 10b constitute respective end surfaces in a direction along center axis 10e. Bottom surface 10b is a surface opposite to upper surface 10a. Inner circumferential surface 10c and outer circumferential surface 10d are continuous to upper surface 10a and bottom surface 10b. A distance between inner circumferential surface 10c and center axis 10e is smaller than a distance between outer circumferential surface 10d and center axis 10e. A raceway groove is provided in outer circumferential surface 10d Upper surface 10a, bottom surface 10b, inner circumferential surface 10c, and outer circumferential surface 10d constitute a surface of inner ring 10. Outer circumferential surface 10d constitutes a raceway surface of inner ring 10.

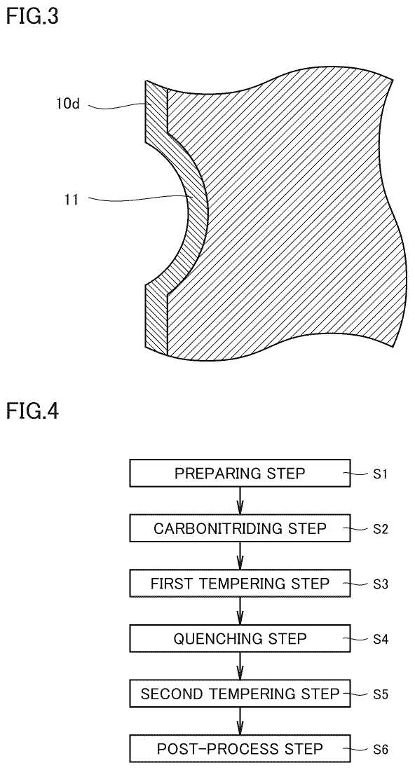

FIG. 3 is an enlarged view at III in FIG. 2. As shown in FIG. 3, inner ring 10 has a quench-hardened layer 11. Quench-hardened layer 11 is provided in the surface of inner ring 10. Quench-hardened layer 11 is provided at least in outer circumferential surface 10d of the surfaces of inner ring 10, outer circumferential surface 10d forming a raceway surface. Quench-hardened layer 11 is provided in all the surfaces of inner ring 10, for example. Quench-hardened layer 11 includes a plurality of martensite crystal grains. Each of the plurality of martensite crystal grains is a crystal grain constituted of a martensite phase.

When a deviation is more than or equal to 15° between the crystal orientation of a first martensite crystal grain and the crystal orientation of a second martensite crystal grain adjacent to the first martensite crystal grain, the first and second martensite crystal grains are different martensite crystal grains. On the other hand, when the deviation is less than 15° between the crystal orientation of the first martensite crystal grain and the crystal orientation of the second martensite crystal grain adjacent to the first martensite crystal grain, the first and second martensite crystal grains constitute one martensite crystal grain.

Quench-hardened layer 11 has a structure mainly composed of the martensite phase. More specifically, a ratio of a total area of the plurality of martensite crystal grains in quench-hardened layer 11 is more than or equal to 70%. The ratio of the total area of the plurality of martensite crystal grains in quench-hardened layer 11 may be more than or equal to 80%.

In addition to the martensite crystal grains, quench-hardened layer 11 includes a plurality of austenite crystal grains and a plurality of cementite crystal grains. A ratio of a total area of the austenite crystal grains in quench-hardened layer 11 is preferably less than or equal to 30%. The ratio of the total area of the austenite crystal grains in quench-hardened layer 11 is more preferably less than or equal to 20%.

When a deviation is more than or equal to 15° between the crystal orientation of a first cementite crystal grain and the crystal orientation of a second cementite crystal grain adjacent to the first cementite crystal grain, the first and second cementite crystal grains are different cementite crystal grains. On the other hand, when the deviation is less than 15° between the crystal orientation of the first cementite crystal grain and the crystal orientation of the second cementite crystal grain adjacent to the first cementite crystal grain, the first and second cementite crystal grains constitute one cementite crystal grain.

The plurality of martensite crystal grains are classified into a first group and a second group. A minimum value of crystal grain sizes of the martensite crystal grains belonging to the first group is larger than a maximum value of crystal grain sizes of the martensite crystal grains belonging to the second group.

A value obtained by dividing a total area of the martensite crystal grains belonging to the first group by the total area of the plurality of martensite crystal grains (the sum of the total area of the martensite crystal grains belonging to the first group and the total area of the martensite crystal grains belonging to the second group) is more than or equal to 0.3.

A value obtained by dividing, by the total area of the plurality of martensite crystal grains, the total area of the martensite crystal grains belonging to the first group except for a martensite crystal grain that has a minimum crystal grain size and that belongs to the first group is less than 0.3.

From another viewpoint, it can be said that the plurality of martensite crystal grains are assigned to the first group in the order from one having the largest crystal grain size. The assignment to the first group is ended when the total area of the martensite crystal grains assigned to the first group until then becomes 0.3 or more time as large as the total area of the plurality of martensite crystal grains. A remainder of the plurality of martensite crystal grains are assigned to the second group.

An average grain size of the martensite crystal grains belonging to the first group is less than or equal to 1.5 μm. The average grain size of the martensite crystal grains belonging to the first group is preferably less than or equal to 1.3 μm. The average grain size of the martensite crystal grains belonging to the first group is more preferably less than or equal to 1.26 μm, and the average grain size is particularly preferably less than or equal to 1.24 μm. The average grain size of the martensite crystal grains belonging to the first group is more preferably less than or equal to 1.2 μm.

An average aspect ratio of the martensite crystal grains belonging to the first group is less than or equal to 3.3. The average aspect ratio of the martensite crystal grains belonging to the first group is preferably less than or equal to 3.2. The average aspect ratio of the martensite crystal grains belonging to the first group is more preferably less than or equal to 3.1, and the average aspect ratio is particularly preferably less than or equal to 2.9.

The condition that the average aspect ratio of the plurality of crystal grains belonging to the first group is less than or equal to 3.3 is more preferably a condition provided for a bearing part having such a characteristic that the average grain size of the plurality of martensite crystal grains belonging to the first group is less than or equal to 1.5 μm. However, in the present embodiment, a bearing part not having such a characteristic that the average grain size of the plurality of martensite crystal grains belonging to the first group is less than or equal to 1.5 μm may satisfy only such a condition that the average aspect ratio of the plurality of martensite crystal grains is less than or equal to 3.3.

The average crystal grain size of the martensite crystal grains belonging to the first group and the aspect ratio of each of the martensite crystal grains belonging to the first group are measured using an EBSD (Electron Backscattered Diffraction) method.

This will be described more in detail as follows. First, a cross section image (hereinafter, referred to as “EBSD image”) in quench-hardened layer 11 is captured based on the EBSD method. The EBSD image is captured to include a sufficient number (more than or equal to 20) of martensite crystal grains. A boundary between adjacent martensite crystal grains is specified based on the crystal orientation of each crystal grain in the EBSD image Second, based on the specified boundary between the martensite crystal grains, the area and shape of each martensite crystal grain in the EBSD image are calculated.

More specifically, by calculating the square root of a value obtained by dividing the area of each martensite crystal grain in the EBSD image by π/4, the equivalent circle diameter of each martensite crystal grain in the EBSD image is calculated.

Based on the equivalent circle diameter of each martensite crystal grain calculated as described above, the martensite crystal grains belonging to the first group among the martensite crystal grains in the EBSD image are determined. A value obtained by dividing, by the total area of the martensite crystal grains in the EBSD image, the total area of the martensite crystal grains belonging to the first group among the martensite crystal grains in the EBSD image is regarded as the value obtained by dividing the total area of the martensite crystal grains belonging to the first group by the total area of the plurality of martensite crystal grains.

Based on the equivalent circle diameter of each martensite crystal grain calculated as described above, the martensite crystal grains in the EBSD image are classified into the first group and the second group. A value obtained by dividing, by the number of the martensite crystal grains classified into the first group in the EBSD image, the total of the equivalent circle diameters of the martensite crystal grains classified into the first group in the EBSD image is regarded as the average grain size of the martensite crystal grains belonging to the first group.

From the shape of each martensite crystal grain in the EBSD image, the shape of each martensite crystal grain in the EBSD image is approximated to an ellipse by the least squares method. This approximation to an ellipse by the least squares method is performed in accordance with a method described in S. Biggin and D. J. Dingley, Journal of Applied Crystallography, (1977) 10, 376-378. By dividing the size in the major axis by the size in the minor axis in this elliptical shape, the aspect ratio of each martensite crystal grain in the EBSD image is calculated. A value obtained by dividing the total of the aspect ratios of the martensite crystal grains classified into the first group in the EBSD image by the number of the martensite crystal grains classified into the first group in the EBSD image is regarded as the average aspect ratio of the martensite crystal grains belonging to the first group.

In quench-hardened layer 11, the number density of the cementite crystal grains each having a grain size of more than or equal to 1 μm is more than or equal to 0.025/μm². Preferably, the number density of the cementite crystal grains each having a grain size of more than or equal to 1 μm is more than or equal to 0.040/μm². More preferably, the number density of the cementite crystal grains each having a grain size of more than or equal to 1 μm is more than or equal to 0.046/μm².

The grain sizes and number density of the cementite crystal grains in quench-hardened layer 11 are measured in the following manner. First, a cross sectional image (EBSD image) of quench-hardened layer 11 is captured based on the EBSD method. A grain boundary of each cementite crystal grain is specified based on the crystal orientation of each crystal grain in the EBSD image. Second, an area of each cementite crystal grain included in the EBSD image is calculated, and an equivalent circle diameter of each cementite crystal grain is calculated as the square root of a value obtained by dividing the calculated area by π/4. The equivalent circle diameter of each cementite crystal grain calculated in this manner is regarded as the grain size of each cementite crystal grain.

Third, the number of cementite crystal grains each having an equivalent circle diameter of more than or equal to 1 m among the cementite crystal grains included in the EBSD image is counted. A value obtained by dividing, by the area of the observation field of the EBSD image, the counted number of the cementite crystal grains each having an equivalent circle diameter of more than or equal to 1 μm is regarded as the number density of the cementite crystal grains each having a grain size of more than or equal to 1 μm in quench-hardened layer 11.

Quench-hardened layer 11 contains nitrogen. An average nitrogen concentration of quench-hardened layer 11 is preferably more than or equal to 0.15 mass % between the surface (outer circumferential surface 10d) and a position at a distance of 10 μm from the surface. This average nitrogen concentration is less than or equal to 0.20 mass %, for example. It should be noted that this average nitrogen concentration is measured using an EPMA (Electron Probe Micro Analyzer).

A remaining austenite amount in the surface (outer circumferential surface 10d) is more than or equal to 20 volume %. Preferably, the remaining austenite amount in the surface (outer circumferential surface 10d) is more than or equal to 24 volume % and less than or equal to 26 volume %. The remaining austenite amount in the surface (outer circumferential surface 10d) is measured by performing an X-ray diffraction method onto the surface. Specifically, the remaining austenite amount is calculated by comparing the integrated intensity of the X-ray diffraction peak of the austenite phase with the integrated intensity of the X-ray diffraction peak of the martensite phase.

A hardness of quench-hardened layer 11 in the surface (outer circumferential surface 10d) is preferably more than or equal to 730 Hv. It should be noted that the hardness of quench-hardened layer 11 in the surface is measured in accordance with JIS (JIS Z 2244: 2009).

(Method for Manufacturing Bearing Part According to First Embodiment)

A method for manufacturing inner ring 10 will be described below as an exemplary method for manufacturing the bearing part according to the first embodiment.

FIG. 4 is a flowchart showing the method for manufacturing the bearing part according to the embodiment. As shown in FIG. 4, the method for manufacturing the bearing part according to the embodiment includes a preparing step S1, a carbonitriding step S2, a first tempering step S3, a quenching step S4, a second tempering step S5, and a post-process step S6.

In preparing step S1, there is prepared a processing target member having a ring shape and to be formed into inner ring 10 by performing carbonitriding step S2, first tempering step S3, quenching step S4, second tempering step S5 and post-process step S6 thereto. In preparing step S1, first, the processing target member is subjected to hot forging. In preparing step S1, second, the processing target member is subjected to cold forging. The cold forging is preferably performed to attain a diameter expansion ratio (the diameter of the processing target member after the cold forging/the diameter of the processing target member before the cold forging) of more than or equal to 1.1 and less than or equal to 1.3. In preparing step S1, third, cutting is performed to provide the processing target member with a shape close to the shape of inner ring 10.

In carbonitriding step S2, first, the processing target member is carbonitrided by heating the processing target member to a temperature of more than or equal to a first temperature in a carbonitriding atmosphere (atmospheric gas including carbon and nitrogen (atmospheric gas including, for example, endothermic converted gas (RX gas) and ammonia (NH₃) gas)). The first temperature is a temperature of more than or equal to an A₁ transformation point of the steel of the processing target member. In carbonitriding step S2, second, the processing target member is cooled. This cooling is performed such that the temperature of the processing target member becomes less than or equal to an Ms transformation point. An average cooling rate on that occasion is at least 20° C./second.

In first tempering step S3, the processing target member is tempered. First tempering step S3 is performed by holding the processing target member at a second temperature for a first period of time. The second temperature is a temperature of less than the A₁ transformation point. The second temperature is more than or equal to 160° C. and less than or equal to 400° C., for example. Preferably, the second temperature is more than or equal to 180° C. More preferably, the second temperature is more than or equal to 250° C. and less than or equal to 350° C. The first period of time is more than or equal to 1 hour and less than or equal to 4 hours, for example.

In quenching step S4, the processing target member is quenched. In quenching step S4, first, the processing target member is heated to a third temperature in an atmospheric gas in which ammonia is not added intentionally. The third temperature is a temperature of more than or equal to the A₁ transformation point of the steel of the processing target member. The third temperature is preferably less than the first temperature. In quenching step S4, second, the processing target member is cooled. This cooling is performed such that the temperature of the processing target member becomes less than or equal to the Ms transformation point.

In second tempering step S5, the processing target member is tempered. Second tempering step S5 is performed by holding the processing target member at a fourth temperature for a second period of time. The fourth temperature is a temperature of less than the A₁ transformation point. The fourth temperature is more than or equal to 160° C. and less than or equal to 200° C., for example. The second period of time is more than or equal to 1 hour and less than or equal to 4 hours, for example. It should be noted that each of quenching step S4 and second tempering step S5 may be repeated multiple times.

In post-process step S6, the processing target member is post-processed. In post-process step S6, cleaning of the processing target member, machining of a surface of the processing target member, such as grinding or polishing, and the like are performed, for example. In this way, inner ring 10 is manufactured.

### Effects of Bearing Part According to First Embodiment

The following describes effects of the bearing part according to the first embodiment.

When material failure is considered in accordance with the weakest link model, portions each having a relatively low strength, i.e., martensite crystal grains each having a relatively large crystal grain size have a great influence on the material failure. In quench-hardened layer 11 of inner ring 10, the average grain size of the martensite crystal grains belonging to the first group is less than or equal to 1.5 μm. Therefore, since even the martensite crystal grains belonging to the first group and having relatively large crystal grains are fine in inner ring 10, the surface (outer circumferential surface 10d) of quench-hardened layer 11 has a high wear resistance and a high indentation formation resistance.

In quench-hardened layer 11, since the number density of the cementite crystal grains each having a grain size of more than or equal to 1 μm is more than or equal to 0.0254 μm², the cementite grains are dispersed at a high density as compared with a case where the number density of the cementite crystal grains each having a grain size of more than or equal to 1 μm is less than 0.025/μm². Therefore, shear resistance of quench-hardened layer 11 is increased as compared with the shear resistance of the quench-hardened layer in which the number density of the cementite crystal grains each having a grain size of more than or equal to 1 μm is less than 0.025/μm², thereby improving wear resistance of the surface (outer circumferential surface 10d) of quench-hardened layer 11.

As the average aspect ratio of the martensite crystal grains becomes smaller, the shape of each of the martensite crystal grains becomes closer to a spherical shape, with the result that the martensite crystal grains are less likely to become sources of stress concentration. When the average aspect ratio of the martensite crystal grains belonging to the first group is less than or equal to 3.3, the martensite crystal grains each having a relatively large grain size in quench-hardened layer 11 are less likely to become sources of stress concentration. Therefore, the wear resistance and indentation formation resistance of the surface (outer circumferential surface 10d) of quench-hardened layer 11 are improved as compared with a case where the average aspect ratio of the martensite crystal grains belonging to the first group is more than 3.3.

Further, when the average aspect ratio of the martensite crystal grains belonging to the first group is less than or equal to 3.1, the wear resistance and indentation formation resistance of the surface (outer circumferential surface 10d) of quench-hardened layer 11 are improved as compared with a case where the average aspect ratio of the martensite crystal grains belonging to the first group is more than 3.1.

When the average nitrogen concentration of quench-hardened layer 11 is more than or equal to 0.15 mass % between the surface (outer circumferential surface 10d) and a position at a distance of 10 m from the surface, fine precipitates contributing to formation of fine martensite crystal grains are precipitated at the surface (outer circumferential surface 10d) of quench-hardened layer 11.

When the remaining austenite amount in the surface (outer circumferential surface 10d) is more than or equal to 20 volume %, high toughness is provided to the surface (outer circumferential surface 10d) of quench-hardened layer 11.

When the hardness of quench-hardened layer 11 in the surface (outer circumferential surface 10d) is more than or equal to 730 Hv, the surface has a high wear resistance and a high indentation formation resistance.

The steel of inner ring 10 is a high carbon chromium bearing steel. If the steel of the inner ring is a low carbon steel, it is required to perform a carbonizing process for a long period of time so as to quench-harden the steel. Further, the contents of expensive alloy elements, such as molybdenum (Mo) and nickel (Ni), in the low carbon steel (for example, chromium molybdenum steel SCM435 defined in JIS) are larger than those of the high carbon chromium bearing steel. Therefore, manufacturing cost of inner ring 10 composed of the high carbon chromium bearing steel is less than that of the inner ring composed of the low carbon steel. Preferably, the steel of inner ring 10 is a high carbon chromium bearing steel SUJ2 defined in JIS. SUJ2 is particularly inexpensive among high carbon chromium bearing steels.

It should be noted that in the present embodiment, the average grain size and average aspect ratio of the martensite crystal grains belonging to the first group as calculated based on the EBSD image of quench-hardened layer 11 are specified. There are the following advantages in the method for calculating the average grain size and average aspect ratio of the martensite crystal grains belonging to the first group based on the EBSD image: the grain boundaries of the martensite crystal grains belonging to the first group and each having a relatively low strength can be readily known when material failure is considered in accordance with the weakest link model; an influence of very small grains included in the EBSD image can be excluded; the measurement and calculation can be performed mechanically and automatically; and the like.

The method for manufacturing the bearing part according to the present embodiment includes first tempering step S3 after carbonitriding step S2 and before quenching step S4 of heating the formed body to the third temperature that is less than the heating temperature (first temperature) in carbonitriding step S2. The present inventors have found that by performing first tempering step S3 between carbonitriding step S2 and quenching step S4 and setting the second temperature in first tempering step S3 to be more than or equal to 180° C., the martensite crystal grains in quench-hardened layer 11 can become fine, thereby improving the wear resistance and indentation formation resistance of the surface of quench-hardened layer 11. In particular, it has been confirmed that when the second temperature is set to be more than or equal to 250° C. and less than or equal to 350° C., the martensite crystal grains in quench-hardened layer 11 can become finer, thereby further improving the wear resistance and indentation formation resistance of the surface of quench-hardened layer 11.

(Rolling Part According to First Embodiment)

A rolling part according to the first embodiment is a part having a rolling contact surface. The rolling part according to the embodiment has the same configuration as that of the above-described bearing part according to the embodiment, and has the same quench-hardened layer as quench-hardened layer 11. In the rolling part according to the embodiment, the quench-hardened layer is provided in at least the rolling contact surface. A method for manufacturing the rolling part according to the embodiment has the same configuration as that of the above-described method for manufacturing the bearing part according to the embodiment. The rolling part according to the embodiment may be any part having a rolling contact surface such as a ball screw.

(Static Load Capacity Test)

The following describes a static load capacity test performed to confirm the effects of the bearing part according to the first embodiment.

<Test Specimens>

Samples 1, 2, and 3 serving as examples of the present disclosure and samples 4 and 5 serving as comparative examples were used in the static load capacity test Each of samples 1, 2, 3, 4, and 5 was composed of a high carbon chromium bearing steel SUJ2 defined in JIS.

Each of samples 1 to 3 was prepared in accordance with the method for manufacturing the bearing part according to the embodiment. More specifically, in the preparation of sample 1, the first temperature was set to 850° C., the second temperature was set to 180° C., the third temperature was set to 810° C., and the fourth temperature was set to 180° C. In the preparation of sample 2, the first temperature was set to 850° C., the second temperature was set to 250° C., the third temperature was set to 810° C., and the fourth temperature was set to 180° C. In the preparation of sample 3, the first temperature was set to 850° C., the second temperature was set to 350° C., the third temperature was set to 810° C., and the fourth temperature was set to 180° C. Heating conditions for samples 1 to 3 are shown in Table 1. A heat pattern in the carbonitriding process onto each of samples 1 to 3 was a general one. A heating time (first period of time) in the first tempering step for each of samples 1 to 3 was set to 2 hours.

TABLE 1

| | First | Second | Third | Fourth |
|---|---|---|---|---|
| | Temperature | Temperature | Temperature | Temperature |
| | (° C.) | (° C.) | (° C.) | (° C.) |
| Sample 1 | 850 | 180 | 810 | 180 |
| Sample 2 | 850 | 250 | 810 | 180 |
| Sample 3 | 850 | 350 | 810 | 180 |

Sample 4 was prepared by quenching the formed body in a carbonitriding atmosphere and then tempering the formed body. In the preparation of sample 4, the quenching temperature was set to 850° C. and the tempering temperature was set to 180° C.

Sample 5 was prepared by quenching (normal quenching) the formed body in an atmosphere to which ammonia was not intentionally added and then tempering the formed body. In the preparation of sample 5, the quenching temperature was set to 810° C. and the tempering temperature was set to 180° C.

It should be noted that in each of samples 1 to 3, a ratio of a total area of austenite crystal grains at a position at a distance of 50 μm from the surface was more than or equal to 24% and less than or equal to 26%. In each of samples 1 to 4, a nitrogen concentration was more than or equal to 0.15 mass % and less than or equal to 0.20 mass % between the surface and a position at a distance of 10 μm from the surface. In each of samples 1 to 3, a hardness in the surface was about 750 Hv.

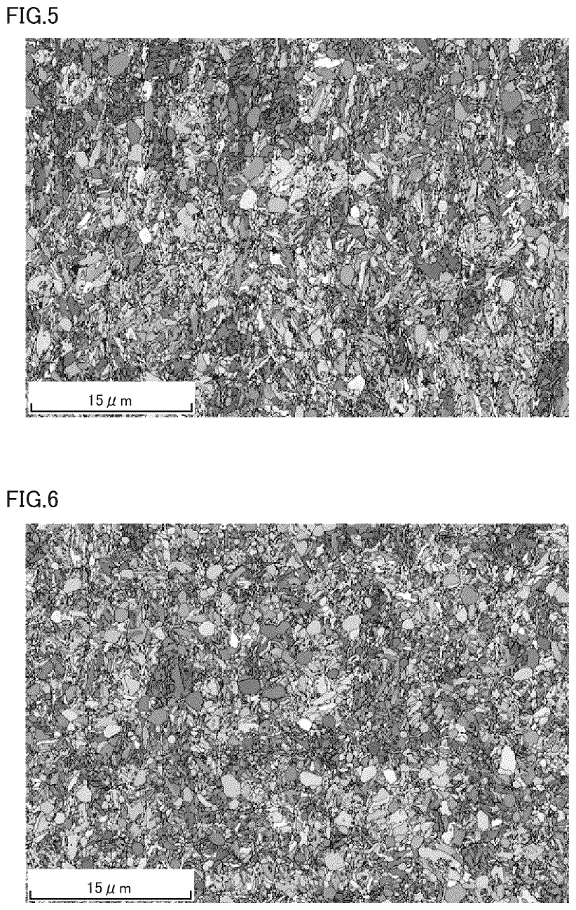

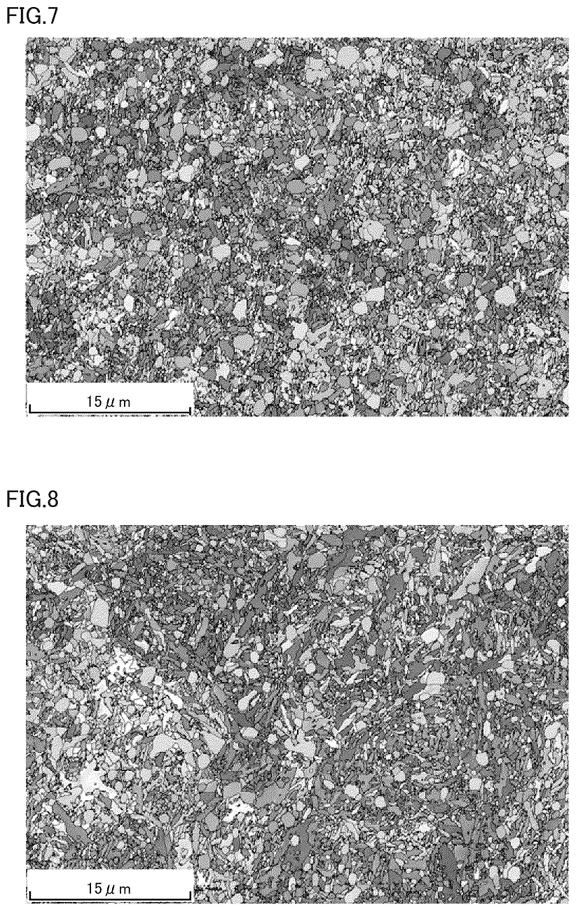

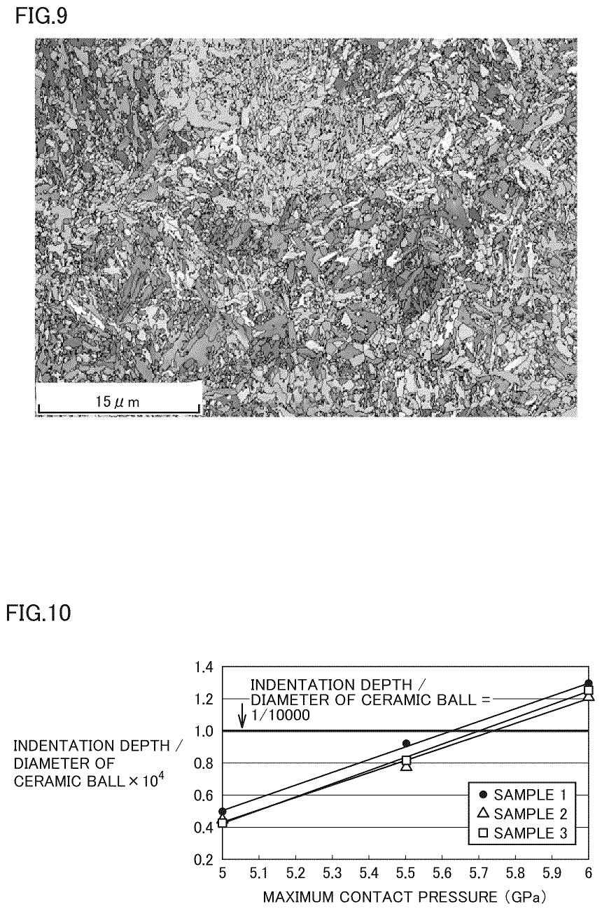

A cross sectional observation of the vicinity of the surface of each of samples 1 to 5 was performed using a field emission scanning electron microscope (FE-SEM), thereby obtaining an EBSD image. FIG. 5 shows an EBSD image at a cross section of sample 1. FIG. 6 shows an EBSD image at a cross section of sample 2. FIG. 7 shows an EBSD image at a cross section of sample 3. FIG. 8 shows an EBSD image at a cross section of sample 4. FIG. 9 shows an EBSD image at a cross section of sample 5. From each of the EBSD images shown in FIGS. 5 to 9, the average grain size and average aspect ratio of the martensite crystal grains belonging to the first group and the grain sizes and number density of the cementite crystal grains in each of samples 1 to 5 were calculated.

In sample 1, the average grain size of the martensite crystal grains belonging to the first group was 1.5 μm, and the average aspect ratio of the martensite crystal grains belonging to the first group was 3.3. In sample 1, the number density of the cementite grains each having a grain size of more than or equal to 1 m was 0.026/μm².

In sample 2, the average grain size of the martensite crystal grains belonging to the first group was 1.2 μm, and the average aspect ratio of the martensite crystal grains belonging to the first group was 2.9. In sample 2, the number density of the cementite grains each having a grain size of more than or equal to 1 μm was 0.048/μm².

In sample 3, the average grain size of the martensite crystal grains belonging to the first group was 1.3 μm, and the average aspect ratio of the martensite crystal grains belonging to the first group was 2.9. In sample 1, the number density of the cementite grains each having a grain size of more than or equal to 1 μm was 0.046/μm².

In sample 4, the average grain size of the martensite crystal grains belonging to the first group was 1.8 μm, and the average aspect ratio of the martensite crystal grains belonging to the first group was 3.2. In sample 4, the number density of the cementite grains each having a grain size of more than or equal to 1 μm was 0.024/μm².

In sample 5, the average grain size of the martensite crystal grains belonging to the first group was 2.1 μm, and the average aspect ratio of the martensite crystal grains belonging to the first group was 3.2. In sample 5, the number density of the cementite grains each having a grain size of more than or equal to 1 μm was 0.005/μm².

Table 2 shows measurement results of the average grain size and average aspect ratio of the martensite crystal grains belonging to the first group and the number density of the cementite crystal grains in each of samples 1 to 5.

TABLE 2

| | | | Cementite |
|---|---|---|---|
| | Martensite Crystal Grains of First Group | | Crystal Grains |
| | Average | Average | Number |
| | Grain Size (μm) | Aspect Ratio | Density (/μm²) |
| Sample 1 | 1.5 | 3.3 | 0.026 |
| Sample 2 | 1.2 | 2.9 | 0.048 |
| Sample 3 | 1.3 | 2.9 | 0.046 |
| Sample 4 | 1.8 | 3.2 | 0.024 |
| Sample 5 | 2.1 | 3.2 | 0.005 |

<Static Load Capacity Test Conditions>

In the static load capacity test, flat plate-like members were produced using samples 1 to 5. The static load capacity test was performed by finding a relation between the maximum contact pressure and the indentation depth by pressing a ceramic ball composed of silicon nitride against a surface of each of the flat plate-like members having been mirror-finished. It should be noted that the static load capacity was evaluated in accordance with the maximum contact pressure when a value obtained by dividing the indentation depth by the diameter of the ceramic ball reached 1/10000 (when a value obtained by dividing the indentation depth by the diameter of the ceramic ball and multiplying by 10000 reached 1).

<Static Load Capacity Test Results>

A ratio (electrostatic load capacity ratio) obtained by normalizing the static load capacity measured in each of samples 1 to 4 by the static load capacity measured in sample 5 is shown in Table 3.

TABLE 3

| | Static Load Capacity Ratio |
|---|---|
| Sample 1 | 1.07 |
| Sample 2 | 1.09 |
| Sample 3 | 1.09 |
| Sample 4 | 0.99 |
| Sample 5 | 1.00 |

As shown in Table 3, it was confirmed that the static load capacity of each of samples 1 to 3 is higher than the static load capacity of each of samples 4 and 5. It was confirmed that the static load capacity of each of samples 2 and 3 is higher than the static load capacity of sample 1.

FIG. 10 is a graph showing a relation between the maximum contact pressure and the indentation depth. In FIG. 10, the horizontal axis represents the maximum contact pressure (unit: GPa), and the vertical axis represents a value obtained as follows: the indentation depth/the diameter of the ceramic ball×10⁴. As shown in FIG. 10, when the value of the vertical axis was 1, the value of the maximum contact pressure in each of curves corresponding to samples 2 and 3 was larger than that in a curve corresponding to sample 1. That is, the value of the static load capacity in each of samples 2 and 3 was larger than that in sample 1.

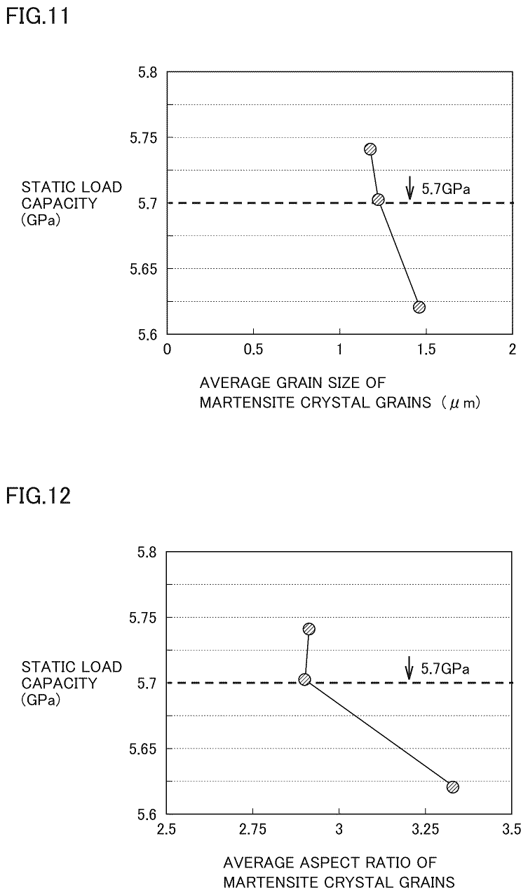

FIG. 11 is a graph showing a relation between the average grain size of the martensite crystal grains belonging to the first group and the static load capacity. FIG. 12 is a graph showing a relation between the average aspect ratio of the martensite crystal grains belonging to the first group and the static load capacity. In FIG. 11, the horizontal axis represents the average grain size (unit: μm) of the martensite crystal grains belonging to the first group, and the vertical axis represents the static load capacity (unit. GPa). In FIG. 12, the horizontal axis represents the average aspect ratio of the martensite crystal grains belonging to the first group, and the vertical axis represents the static load capacity (unit: GPa).

As shown in Tables 2 and 3 and FIGS. 11 and 12, the static load capacity was more improved as the average grain size of the martensite crystal grains belonging to the first group was smaller. Further, the static load capacity was more improved as the number density of the cementite grains each having a grain size of more than or equal to 1 μm was larger. Further, the static load capacity was more improved as the average aspect ratio of the martensite crystal grains belonging to the first group was smaller. It was confirmed that a static load capacity of more than or equal to 5.6 GPa can be achieved when the average grain size of the martensite crystal grains belonging to the first group is less than or equal to 1.5 μm and the number density of the cementite grains each having a grain size of more than or equal to 1 μm is 0.005/μm². Further, it was confirmed that when the average grain size of the martensite crystal grains belonging to the first group is less than or equal to 1.4 μm and the average aspect ratio of the martensite crystal grains belonging to the first group is less than or equal to 3.1, a static load capacity of more than or equal to 5.7 GPa can be achieved.

From such test results, it has been also experimentally indicated that according to the rolling part according to the embodiment, the static load capacity (indentation formation resistance) are improved due to the fine crystal grains.

(Wear Test)

The following describes a wear test performed to confirm the effects of the rolling part according to the embodiment.

Samples 1 to 5 described above were used for the wear test. In the wear test, flat plate-like members was produced using samples 1 to 5. A surface roughness (arithmetic mean roughness) Ra was set to 0.010 μm.

<Wear Test Conditions>

Each of samples 1 to 5 was subjected to the wear test using a Savin type wear testing machine. A load in the test was set to 50 N and a relative speed with respect to a counterpart material was set to 0.05 m/s. A test time was set to 60 minutes, and Mobil Velocite Oil No. 3 (registered trademark) (VG2) was used for the lubricating oil. Wear resistance was evaluated by comparing the wear amounts of samples 1 to 5 after the wear test.

<Wear Test Results>

Results of evaluation by the comparison among the wear amounts of samples 1 to 5 are shown in Table 4. It was determined that smaller wear amounts are indicated in the order of A, B, and C.

TABLE 4

| | Evaluation on Wear Amount |
|---|---|
| Sample 1 | B |
| Sample 2 | A |
| Sample 3 | A |
| Sample 4 | B |
| Sample 5 | C |

As shown in Table 4, it was confirmed that the wear resistance of each of samples 1 to 3 is higher than that of sample 5. It was confirmed that the wear resistance of each of samples 2 and 3 is higher than that of sample 1.

That is, the wear resistance is more improved as the average grain size of the martensite crystal grains belonging to the first group is smaller. Further, the wear resistance is more improved as the number density of cementite grains each having a grain size of more than or equal to 1 μm is larger. Further, the wear resistance is more improved as the average aspect ratio of the martensite crystal grains belonging to the first group is smaller.

From such test results, it has been also experimentally indicated that according to the rolling part according to the embodiment, the wear resistance are improved due to the fine crystal grains.

### Second Embodiment

A bearing part according to a second embodiment is composed of a high carbon chromium bearing steel, and has a quench-hardened layer in a surface thereof. The quench-hardened layer includes a plurality of martensite crystal grains. The maximum grain size of the plurality of martensite crystal grains is less than or equal to 3.5 μm. The maximum aspect ratio of the plurality of martensite crystal grains is less than or equal to 10. A ratio of the maximum value to the minimum value of a crystal orientation density of {011} planes of the plurality of martensite crystal grains is less than or equal to 5.0.

When the plurality of martensite crystal grains are classified into below-described first group and second group in the bearing part, the average grain size of the martensite crystal grains belonging to the first group may be less than or equal to 11 μm. A minimum value of crystal grain sizes of the martensite crystal grains belonging to the first group is larger than a maximum value of crystal grain sizes of the martensite crystal grains belonging to the second group A value obtained by dividing a total area of the martensite crystal grains belonging to the first group by a total area of the plurality of martensite crystal grains is more than or equal to 0.5. A value obtained by dividing, by the total area of the plurality of martensite crystal grains, a total area of the martensite crystal grains belonging to the first group except for a martensite crystal grain that has a minimum crystal grain size and that belongs to the first group is less than 0.5.

Further, when the plurality of martensite crystal grains are classified into below-described third group and fourth group in the bearing part, the average grain size of the martensite crystal grains belonging to the third group may be less than or equal to 0.8 μm. A minimum value of crystal grain sizes of the martensite crystal grains belonging to the third group is larger than a maximum value of crystal grain sizes of the martensite crystal grains belonging to the fourth group. A value obtained by dividing the total area of the martensite crystal grains belonging to the third group by the total area of the plurality of martensite crystal grains is more than or equal to 0.7. A value obtained by dividing, by the total area of the plurality of martensite crystal grains, a total area of the martensite crystal grains belonging to the third group except for a martensite crystal grain that has a minimum crystal grain size and that belongs to the third group is less than 0.7.

In the bearing part, the average aspect ratio of the martensite crystal grains belonging to the first group may be less than or equal to 3.2, and the average aspect ratio of the martensite crystal grains belonging to the third group may be less than or equal to 3.0.

In the bearing part, the quench-hardened layer further includes a plurality of cementite grains. When the plurality of cementite grains are classified into below-described fifth group and sixth group, an average grain size of the cementite grains belonging to the fifth group may be less than or equal to 1.4 μm. The minimum value of the crystal grain sizes of the cementite grains belonging to the fifth group is larger than the maximum value of the cementite grains belonging to the sixth group. A value obtained by dividing a total area of the cementite grains belonging to the fifth group by the total area of the plurality of cementite grains is more than or equal to 0.5. A value obtained by dividing, by the total area of the plurality of cementite grains, the total area of the cementite grains belonging to the fifth group except for a cementite grain that has a minimum crystal grain size and that belongs to the fifth group is less than 0.5.

Further, when the plurality of cementite grains are classified into below-described seventh group and eighth group in the bearing part, an average grain size of the cementite grains belonging to the seventh group may be less than or equal to 1.10 μm. The minimum value of the crystal grain sizes of the cementite grains belonging to the seventh group is larger than the maximum value of the cementite grains belonging to the eighth group. A value obtained by dividing a total area of the cementite grains belonging to the seventh group by the total area of the plurality of cementite grains is more than or equal to 0.7. A value obtained by dividing, by the total area of the plurality of cementite grains, a total area of the cementite grains belonging to the seventh group except for a cementite grain that has a minimum crystal grain size and that belongs to the seventh group is less than 0.7

In the bearing part, the number density of the cementite grains belonging to the fifth group may be more than or equal to 0.05/μm², and the number density of the cementite grains belonging to the seventh group may be more than or equal to 0.10/μm².

In the bearing part, the quench-hardened layer contains nitrogen. An average nitrogen concentration of the quench-hardened layer may be more than or equal to 0.10 mass/o between the surface and a position at a distance of 10 μm from the surface.

In the bearing part, a remaining austenite amount in the surface may be more than or equal to 20 volume %.

In the bearing part, a hardness of the quench-hardened layer in the surface may be more than or equal to 730 Hv.

In the bearing part, an average grain size of prior austenite grains in the surface may be less than or equal to 8 μm.

In the bearing part, a compressive residual stress of the surface is more than or equal to 100 MPa.

In the bearing part, the high carbon chromium bearing steel may be SUJ2 defined in JIS.

A method for manufacturing the bearing part according to the second embodiment includes: a step of preparing a formed body composed of a high carbon chromium bearing steel, a step of performing primary quenching onto the formed body by heating the formed body to a primary quenching temperature that is more than or equal to an A₁ transformation point and then cooling the formed body to a temperature that is less than or equal to an Ms point; a step of performing primary tempering onto the formed body having been through the primary quenching, by holding the formed body for a first period of time at a temperature of more than or equal to 200° C. and less than the A₁ transformation point; a step of performing secondary quenching onto the formed body having been through the primary tempering, by heating the formed body to a temperature of more than or equal to the A₁ transformation point and less than the primary quenching temperature and then cooling the formed body to a temperature that is less than or equal to the Ms point; and a step of performing secondary tempering onto the formed body having been through the secondary quenching, by holding the formed body for a second period of time at a temperature of less than 180° C.

The method for manufacturing the bearing part may further include a step of nitriding the formed body before the step of performing the primary quenching onto the formed body.

(Specific Configuration of Bearing Part According to Second Embodiment)

The following describes a specific configuration of the bearing part according to the second embodiment. It should be noted that in the description below, an inner ring 10 of a rolling bearing will be illustratively described as an exemplary bearing part according to the embodiment; however, the bearing part according to the embodiment is not limited to this. The bearing part according to the embodiment may be at least one of an inner ring, an outer ring, and a rolling element of the rolling bearing. For example, the rolling bearing according to the embodiment may include an inner ring and an outer ring each serving as a ring part according to the embodiment, as well as a rolling element.

Inner ring 10 is composed of a high carbon chromium bearing steel. The high carbon chromium bearing steel is SUJ2 defined in JIS (JIS G 4805: 2008), for example.

Inner ring 10 includes the same configuration as that of inner ring 10 according to the first embodiment. As shown in FIG. 1 and FIG. 2, inner ring 10 has a ring shape. Inner ring 10 has an upper surface 10a, a bottom surface 10b, an inner circumferential surface 10c, an outer circumferential surface 10d, and a center axis 10e.

Upper surface 10a and bottom surface 10b constitute respective end surfaces in a direction along center axis 10e. Bottom surface 10b is a surface opposite to upper surface 10a. Inner circumferential surface 10c and outer circumferential surface 10d are continuous to upper surface 10a and bottom surface 10b. A distance between inner circumferential surface 10c and center axis 10e is smaller than a distance between outer circumferential surface 10d and center axis 10e. A raceway groove is provided in outer circumferential surface 10d Outer circumferential surface 10d constitutes a raceway surface of inner ring 10.

As shown in FIG. 3, inner ring 10 has a quench-hardened layer 11. Quench-hardened layer 11 is provided at least in outer circumferential surface 10d of the surfaces of inner ring 10, outer circumferential surface 10d forming the raceway surface. Quench-hardened layer 11 is provided in all the surfaces of inner ring 10, for example. Quench-hardened layer 11 includes a plurality of martensite crystal grains and a plurality of cementite grains. Each of the plurality of martensite crystal grains is a crystal grain constituted of a martensite phase. Each of the plurality of cementite grains is a compound grain constituted of cementite (Fe₃C).

Each of the martensite crystal grains is a block grain of a martensite phase constituted of crystals with crystal orientations being aligned. When a deviation is more than or equal to 15° between the crystal orientation of a first martensite crystal grain and the crystal orientation of a second martensite crystal grain adjacent to the first martensite crystal grain, the first and second martensite crystal grains are different martensite crystal grains. On the other hand, when the deviation is less than 15° between the crystal orientation of the first martensite crystal grain and the crystal orientation of the second martensite crystal grain adjacent to the first martensite crystal grain, the first and second martensite crystal grains constitute one martensite crystal grain.

The maximum grain size of the martensite crystal grains in quench-hardened layer 11 is less than or equal to 3.5 μm. The maximum grain size of the martensite crystal grains in quench-hardened layer 11 is, for example, more than or equal to 3.2 μm. The maximum grain size of the martensite crystal grains is measured using an EBSD (Electron Backscattered Diffraction) method.

Specifically, first, an image (hereinafter, referred to as “EBSD image”) in the surface of quench-hardened layer 11 is captured based on the EBSD method. The EBSD image is captured to include a sufficient number (more than or equal to 20) of martensite crystal grains. A boundary between adjacent martensite crystal grains is specified based on the EBSD method. Second, based on the specified boundary between the martensite crystal grains, the area and shape of each martensite crystal grain in the EBSD image are calculated.

More specifically, by calculating the square root of a value obtained by dividing the area of each martensite crystal grain in the EBSD image by π/4, the equivalent circle diameter of each martensite crystal grain in the EBSD image is calculated. The maximum value of the equivalent circle diameters of the martensite crystal grains in the EBSD image is regarded as the maximum grain size of the martensite crystal grains.

The maximum aspect ratio of the martensite crystal grains in quench-hardened layer 11 is less than or equal to 10. Preferably, the maximum aspect ratio of the martensite crystal grains is less than or equal to 9.5. More preferably, the maximum aspect ratio of the martensite crystal grains is less than or equal to 9.1. A method for calculating the maximum aspect ratio of the martensite crystal grains will be described later.

The ratio of the maximum value to the minimum value of the crystal orientation density of the {011} planes of the plurality of martensite crystal grains is less than or equal to 5.0. Preferably, the ratio is less than or equal to 4.1. More preferably, the ratio is less than or equal to 3.6. The minimum value and maximum value of the crystal orientation density are calculated from data measured through the EBSD (Electron Backscattered Diffraction) method by analyzing a crystal orientation density distribution in accordance with a method described in H. J. Bunge, Mathematische Methoden der Texturanalyse, Akademie-Verlag (1969) using a spherical harmonic series.

Quench-hardened layer 11 has a structure mainly composed of the martensite phase. More specifically, a ratio of a total area of the plurality of martensite crystal grains in quench-hardened layer 11 is more than or equal to 70%. The ratio of the total area of the plurality of martensite crystal grains in quench-hardened layer 11 may be more than or equal to 80%. The ratio of the total area of the plurality of cementite grains in quench-hardened layer 11 is more than or equal to 30%.

The plurality of martensite crystal grains are classified into a first group and a second group. According to this classification, the plurality of martensite crystal grains consist of: the plurality of martensite crystal grains belonging to the first group; and the plurality of martensite crystal grains belonging to the second group. A minimum value of crystal grain sizes of the martensite crystal grains belonging to the first group is larger than a maximum value of crystal grain sizes of the martensite crystal grains belonging to the second group.

A value obtained by dividing a total area of the martensite crystal grains belonging to the first group by the total area of the plurality of martensite crystal grains (the sum of the total area of the martensite crystal grains belonging to the first group and the total area of the martensite crystal grains belonging to the second group) is more than or equal to 0.5. A value obtained by dividing, by the total area of the plurality of martensite crystal grains, the total area of the martensite crystal grains belonging to the first group except for a martensite crystal grain that has a minimum crystal grain size and that belongs to the first group is less than 0.5.

From another viewpoint, it can be said that the plurality of martensite crystal grains are assigned to the first group in the order from one having the largest crystal grain size. The assignment to the first group is ended when the total area of the martensite crystal grains assigned to the first group until then becomes 0.5 or more time as large as the total area of the plurality of martensite crystal grains. A remainder of the plurality of martensite crystal grains are assigned to the second group.

An average grain size of the martensite crystal grains belonging to the first group is less than or equal to 1.10 μm. The average grain size of the martensite crystal grains belonging to the first group is preferably less than or equal to 1.00 μm. The average grain size of the martensite crystal grains belonging to the first group is more preferably less than or equal to 0.98 μm.

An aspect ratio of each of the martensite crystal grains belonging to the first group is less than or equal to 3.2. The aspect ratio of each of the martensite crystal grains belonging to the first group is preferably less than or equal to 3.0. The aspect ratio of each of the martensite crystal grains belonging to the first group is more preferably less than or equal to 2.9.

The plurality of martensite crystal grains may be classified into a third group and a fourth group. According to this classification, the plurality of martensite crystal grains consists of: the plurality of martensite crystal grains belonging to the third group; and the plurality of martensite crystal grains belonging to the fourth group. A minimum value of crystal grain sizes of the martensite crystal grains belonging to the third group is larger than a maximum value of crystal grain sizes of the martensite crystal grains belonging to the fourth group.

A value obtained by dividing a total area of the martensite crystal grains belonging to the third group by the total area of the plurality of martensite crystal grains (the sum of the total area of the martensite crystal grains belonging to the third group and the total area of the martensite crystal grains belonging to the fourth group) is more than or equal to 0.7.

A value obtained by dividing, by the total area of the plurality of martensite crystal grains, the total area of the martensite crystal grains belonging to the third group except for a martensite crystal grain that has a minimum crystal grain size and that belongs to the third group is less than 0.7.

From another viewpoint, it can be said that the plurality of martensite crystal grains are assigned to the third group in the order from one having the largest crystal grain size. The assignment to the third group is ended when the total area of the martensite crystal grains assigned to the third group until then becomes 0.7 or more time as large as the total area of the plurality of martensite crystal grains. A remainder of the plurality of martensite crystal grains are assigned to the fourth group.

An average grain size of the martensite crystal grains belonging to the third group is less than or equal to 0.80 μm. The average grain size of the martensite crystal grains belonging to the third group is preferably less than or equal to 0.78 μm. The average grain size of the martensite crystal grains belonging to the third group is more preferably less than or equal to 0.76 μm.

An aspect ratio of each of the martensite crystal grains belonging to the third group is less than or equal to 3.0. The aspect ratio of each of the martensite crystal grains belonging to the third group is preferably less than or equal to 2.95. The aspect ratio of each of the martensite crystal grains belonging to the third group is more preferably less than or equal to 2.75.

The average grain size of the martensite crystal grains belonging to the first group (third group), the average aspect ratio of the martensite crystal grains belonging to the first group (third group), and the maximum aspect ratio of the martensite crystal grains are measured using the EBSD method.

This will be described more in detail as follows. Based on the equivalent circle diameter of each martensite crystal grain calculated as described above, the martensite crystal grains belonging to the first group (third group) among the martensite crystal grains in the EBSD image are determined. In other words, based on the equivalent circle diameter of each martensite crystal grain calculated as described above, the martensite crystal grains in the EBSD image are classified into the first group and the second group (likewise, classified into the third group and the fourth group). The value obtained by dividing, by the number of the martensite crystal grains classified into the first group (third group) in the EBSD image, the total of the equivalent circle diameters of the martensite crystal grains classified into the first group (third group) in the EBSD image is regarded as the average grain size of the martensite crystal grains belonging to the first group (third group). It should be noted that the value obtained by dividing, by the total area of the plurality of martensite crystal grains in the EBSD image, the total area of the martensite crystal grains belonging to the first group (third group) among the plurality of martensite crystal grains in the EBSD image is regarded as the value obtained by dividing the total area of the martensite crystal grains belonging to the first group (third group) by the total area of the plurality of martensite crystal grains.

From the shape of each martensite crystal grain in the EBSD image, the shape of each martensite crystal grain in the EBSD image is approximated to an ellipse by the least squares method. This approximation to an ellipse by the least squares method is performed in accordance with a method described in S. Biggin and D. J. Dingley, Journal of Applied Crystallography, (1977) 10, 376-378. By dividing the size in the major axis by the size in the minor axis in this elliptical shape, the aspect ratio of each martensite crystal grain in the EBSD image is calculated. The maximum value of the aspect ratios of the martensite crystal grains is regarded as the maximum aspect ratio of the martensite crystal grains.

Further, a value obtained by dividing the total of the aspect ratios of the martensite crystal grains classified into the first group (third group) in the EBSD image by the number of the martensite crystal grains classified into the first group (third group) in the FBSD image is regarded as the average aspect ratio of the martensite crystal grains belonging to the first group (third group).

The plurality of cementite grains are classified into a fifth group and a sixth group. According to this classification, the plurality of cementite grains consist of: the plurality of cementite grains belonging to the fifth group; and the plurality of cementite grains belonging to the sixth group. A minimum value of the crystal grain sizes of the cementite grains belonging to the fifth group is larger than a maximum value of the grain sizes of the cementite grains belonging to the sixth group.

A value obtained by dividing a total area of the cementite grains belonging to the fifth group by the total area of the plurality of cementite grains (the sum of the total area of the cementite grains belonging to the fifth group and the total area of the cementite grains belonging to the sixth group) is more than or equal to 0.5. A value obtained by dividing, by the total area of the plurality of cementite grains, the total area of the cementite grains belonging to the fifth group except for a cementite grain that has a minimum grain size and that belongs to the fifth group is less than 0.5.

From another viewpoint, it can be said that the plurality of cementite grains are assigned to the fifth group in the order from one having the largest grain size. The assignment to the fifth group is ended when the total area of the cementite grains assigned to the fifth group until then becomes 0.5 or more time as large as the total area of the plurality of cementite grains. A remainder of the plurality of cementite grains are assigned to the sixth group.

An average grain size of the cementite grains belonging to the fifth group is less than or equal to 1.40 μm. The average grain size of the cementite grains belonging to the fifth group is preferably less than or equal to 1.30 μm. The average grain size of the cementite grains belonging to the fifth group is more preferably less than or equal to 1.20 μm.

The number density of the cementite grains belonging to the fifth group is more than or equal to 0.04/μm². Preferably, the number density of the cementite grains belonging to the fifth group is more than or equal to 0.05/μm². Preferably, the number density of the cementite grains belonging to the fifth group is less than or equal to 1.00/μm².

The plurality of cementite grains may be classified into a seventh group and an eighth group. According to this classification, the plurality of cementite grains consist of: a plurality of cementite grains belonging to the seventh group; and a plurality of cementite grains belonging to the eighth group. A minimum value of the grain sizes of the cementite grains belonging to the seventh group is larger than a maximum value of the grain sizes of the cementite grains belonging to the eighth group.

A value obtained by dividing a total area of the cementite grains belonging to the seventh group by the total area of the plurality of cementite grains (the sum of the total area of the cementite grains belonging to the seventh group and the total area of the cementite grains belonging to the eighth group) is more than or equal to 0.7. A value obtained by dividing, by the total area of the plurality of cementite grains, the total area of the cementite grains belonging to the seventh group except for a cementite grain that has a minimum grain size and that belongs to the seventh group is less than 0.7.

From another viewpoint, it can be said that the plurality of cementite grains are assigned to the seventh group in the order from one having the largest grain size. The assignment to the seventh group is ended when the total area of the cementite grains assigned to the seventh group until then becomes 0.7 or more time as large as the total area of the plurality of cementite grains. A remainder of the plurality of cementite grains are assigned to the eighth group.

The average grain size of the cementite grains belonging to the seventh group is less than or equal to 1.10 μm. Preferably, the average grain size of the cementite grains belonging to the seventh group is less than or equal to 0.90 μm. Further preferably, the average grain size of the cementite grains belonging to the seventh group is less than or equal to 0.60 μm.

The number density of the cementite grains belonging to the seventh group is more than or equal to 0.06/μm². Preferably, the number density of the cementite grains belonging to the seventh group is more than or equal to 0.10/μm². More preferably, the number density of the cementite grains belonging to the seventh group is more than or equal to 0.20/μm². Preferably, the number density of the cementite grains belonging to the seventh group is less than or equal to 1.00/μm².

The average grain size of the cementite grains belonging to the fifth group (seventh group) is measured using the above-described EBSD method in the same manner as in the measurement of the average grain size of the martensite crystal grains belonging to the first group (third group). The number density of the cementite grains belonging to the fifth group (seventh group) is calculated by measuring the number of the cementite grains belonging to the fifth group (seventh group) in the EBSD image captured to include a sufficient number (more than or equal to 20) of martensite crystal grains as described above, and dividing the number of the cementite grains by the area of the visual field of the EBSD image.

Quench-hardened layer 11 contains nitrogen. An average nitrogen concentration of quench-hardened layer 11 is preferably more than or equal to 0.10 mass % between outer circumferential surface 10d and a position at a distance of 10 μm from outer circumferential surface 10d. This average nitrogen concentration is less than or equal to 0.20 mass %, for example. It should be noted that this average nitrogen concentration is measured using an EPMA (Electron Probe Micro Analyzer).

A remaining austenite amount in outer circumferential surface 10d is preferably more than or equal to 20 volume %. The remaining austenite amount is measured by performing an X-ray diffraction method onto outer circumferential surface 10d. Specifically, the remaining austenite amount is calculated by comparing the integrated intensity of the X-ray diffraction peak of the austenite phase with the integrated intensity of the X-ray diffraction peak of the martensite phase.

A hardness of quench-hardened layer 11 in outer circumferential surface 10d is preferably more than or equal to 700 Hv. More preferably, the hardness of quench-hardened layer 11 in outer circumferential surface 10d is more than or equal to 750 Hv.

It should be noted that the hardness of quench-hardened layer 11 in outer circumferential surface 10d is measured in accordance with JIS (JJS Z 2244: 2009).

Quench-hardened layer 11 includes prior austenite grain boundaries in addition to the martensite crystal grains and the cementite grains. Quench-hardened layer 11 has remaining traces of austenite grain boundaries having existed in the steel that has been heated to the quenching temperature and just before being quenched in the primary quenching step or the secondary quenching step of the below-described method for manufacturing the bearing part. The prior austenite grains are crystal grains that are based on the traces and that has existed in the steel just before being quenched.

The average grain size of the prior austenite grains in outer circumferential surface 10d is preferably less than or equal to 8 μm. The average grain size of the prior austenite grains is more preferably less than or equal to 6 μm.

It should be noted that the average grain size of the prior austenite grains in outer circumferential surface 10d is measured by the following method. First, in the cross section including outer circumferential surface 10d, prior austenite grain boundaries, which have appeared due to an acid solution, are captured in image by an optical microscope (in the description below, the image obtained by the optical microscope will be referred to as “optical microscope image”). It should be noted that the optical microscope image is captured to include a sufficient number (more than or equal to 20) of prior austenite grains. Second, image processing based on JIS (JIS G 0551: 2013) is performed to the obtained optical microscope image, thereby calculating the average grain size of the prior austenite grains in the optical microscope image.

A compressive residual stress of outer circumferential surface 10d is preferably more than or equal to 100 MPa. The compressive residual stress is measured by performing an X-ray stress measurement method onto outer circumferential surface 10d.

(Method for Manufacturing Bearing Part According to Second Embodiment)

A method for manufacturing inner ring 10 will be described below as an exemplary method for manufacturing the bearing part according to the second embodiment.

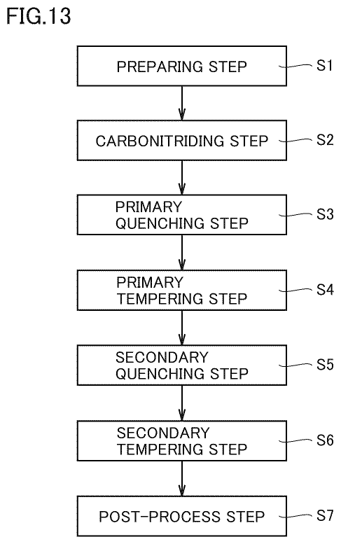

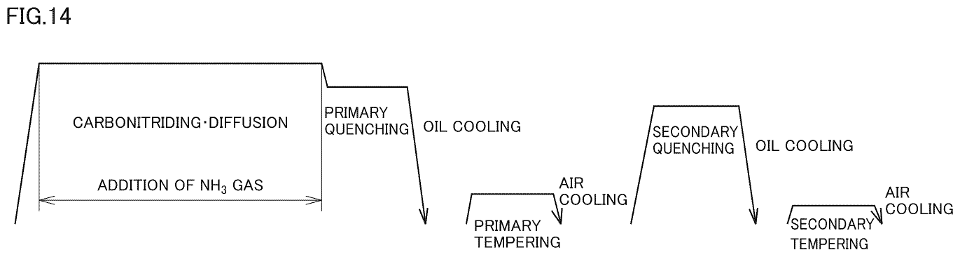

FIG. 13 is a flowchart showing the method for manufacturing the bearing part according to the embodiment. FIG. 14 is a graph showing a heat pattern in the method for manufacturing the bearing part according to the embodiment. As shown in FIGS. 13 and 14, the method for manufacturing the bearing part according to the embodiment includes a preparing step S1, a carbonitriding step S2, a primary quenching step S3, a primary tempering step S4, a secondary quenching step S5, a secondary tempering step S6, and a post-process step S7. Preparing step S1, carbonitriding step S2, primary quenching step S3, primary tempering step S4, secondary quenching step S5, secondary tempering step S6, and post-process step S7 are performed in the described order.

In preparing step S1, there is prepared a processing target member having a ring shape and to be formed into inner ring 10 by performing carbonitriding step S2, primary quenching step S3, primary tempering step S4, secondary quenching step S5, secondary tempering step S6 and post-process step S7 thereto. In preparing step S1, first, the processing target member is subjected to hot forging. In preparing step S1, second, the processing target member is subjected to cold forging. The cold forging is preferably performed to attain a diameter expansion ratio (the diameter of the processing target member after the cold forging/the diameter of the processing target member before the cold forging) of more than or equal to 1.1 and less than or equal to 1.3. In preparing step S1, third, cutting is performed to provide the processing target member with a shape close to the shape of inner ring 10.

In carbonitriding step S2, first, the processing target member is carbonitrided by heating the processing target member prepared in preparing step S1 to a temperature of more than or equal to a first temperature and maintaining the processing target member at the first temperature. The first temperature is a temperature of more than or equal to an Aj transformation point of the steel of the processing target member. In carbonitriding step S2, second, the processing target member is cooled. This cooling is performed such that the temperature of the processing target member becomes less than or equal to an Ms transformation point.

In primary quenching step S3, the processing target member carbonitrided in carbonitriding step S2 is quenched. In primary quenching step S3, first, the processing target member is heated to a second temperature (primary quenching temperature). The second temperature is a temperature of more than or equal to the A₁ transformation point of the steel of the processing target member. The second temperature is preferably less than the first temperature. In primary quenching step S3, second, the processing target member is cooled. This cooling is performed such that the temperature of the processing target member becomes less than or equal to an Ms transformation point. The cooling is performed by oil cooling, for example.

In primary tempering step S4, the processing target member quenched in primary quenching step S3 is tempered. Primary tempering step S4 is performed by holding the processing target member at a third temperature (primary tempering temperature) for a first period of time. The third temperature is a temperature of less than the A₁ transformation point. The third temperature is more than or equal to 200° C. and less than or equal to 450° C., for example. Preferably, the third temperature is more than or equal to 250° C. and less than or equal to 400° C. More preferably, the third temperature is more than or equal to 250° C. and less than or equal to 350° C. The first period of time is more than or equal to 1 hour and less than or equal to 4 hours, for example.

In secondary quenching step S5, the processing target member tempered in primary tempering step S4 is quenched. In secondary quenching step S5, first, the processing target member is heated to a fourth temperature (secondary quenching temperature). The fourth temperature is a temperature of more than or equal to the A₁ transformation point of the steel of the processing target member. The fourth temperature is preferably less than the second temperature. In secondary quenching step S5, second, the processing target member is cooled. This cooling is performed such that the temperature of the processing target member becomes less than or equal to an Ms transformation point. The cooling is performed by oil cooling, for example.

In secondary tempering step S6, the processing target member quenched in secondary quenching step S5 is tempered. Second tempering step S5 is performed by holding the processing target member at a fifth temperature (secondary tempering temperature) for a second period of time. The fifth temperature is a temperature of less than the A₁ transformation point. The fifth temperature is less than the third temperature. The fifth temperature is more than or equal to 140° C. and less than 200° C., for example. Preferably, the fifth temperature is more than or equal to 140° C. and less than or equal to 180° C.

In post-process step S7, the processing target member tempered in secondary tempering step S6 is subjected to a post process. In post-process step S7, cleaning of the processing target member, machining of a surface of the processing target member, such as grinding or polishing, and the like are performed, for example. An amount of grinding or polishing is less than or equal to 200 m, for example. In this way, inner ring 10 is manufactured.

### Functions and Effects

Next, effects of the bearing part according to the embodiment will be described. In inner ring 10, the maximum grain size of the martensite crystal grains in quench-hardened layer 11 is less than or equal to 3.5 μm, and the maximum aspect ratio of the martensite crystal grains in quench-hardened layer 11 is less than or equal to 10. As the maximum grain size of the martensite crystal grains is finer, the wear resistance and toughness of quench-hardened layer 11 are more improved. Further, as the maximum aspect ratio of the martensite crystal grains is closer to 1, the shapes of the martensite crystal grains become closer to spherical shapes, with the result that the martensite crystal grains are less likely to become sources of stress concentration. Thus, the wear resistance and toughness of quench-hardened layer 11 of inner ring 10 are improved as compared with the case where the maximum grain size of the martensite crystal grains in the quench-hardened layer is more than 3.5 μm and the maximum aspect ratio of the martensite crystal grains in the quench-hardened layer is more than 10.

In inner ring 10, the ratio of the maximum value to the minimum value of the crystal orientation density of the {011} planes of the martensite crystal grains in quench-hardened layer 11 is less than or equal to 5.0. As the ratio of the maximum value to the minimum value of the crystal orientation density of the {011} planes of the martensite crystal grains is closer to 1, the respective formation states of the martensite crystal grains are uniform, thereby improving the indentation formation resistance, wear resistance, and toughness. Therefore, the indentation formation resistance, wear resistance, and toughness of quench-hardened layer 11 of inner ring 10 are improved as compared with the case where the ratio of the maximum value to the minimum value of the crystal orientation density of the {011} planes of the martensite crystal grains in the quench-hardened layer is more than 5.0. It should be noted that in the present specification, the indentation formation resistance and the wear resistance are collectively referred to as “surface damage resistance”. Inner ring 10 has improved surface damage resistance and toughness.

When the plurality of martensite crystal grains are classified into the first group and the second group in quench-hardened layer 11 of inner ring 10, the average grain size of the martensite crystal grains belonging to the first group and having relatively large crystal grains is less than or equal to 1.1 μm. When the plurality of martensite crystal grains are classified into the third group and the fourth group in quench-hardened layer 11 of inner ring 10, the average grain size of the martensite crystal grains belonging to the third group and having relatively large crystal grains is less than or equal to 0.8 μm That is, in inner ring 10, even the martensite crystal grains belonging to the first group (third group) and having relatively large crystal grains are fine, thus resulting in improved wear resistance of quench-hardened layer 11.

When the plurality of martensite crystal grains are classified into the first group and the second group in quench-hardened layer 11 of inner ring 10, the average aspect ratio of the martensite crystal grains belonging to the first group and having relatively large crystal grains is less than or equal to 3.2. When the plurality of martensite crystal grains are classified into the third group and the fourth group in quench-hardened layer 11 of inner ring 10, the average aspect ratio of the martensite crystal grains belonging to the third group and having relatively large crystal grains is less than or equal to 3.0. As the average aspect ratio of the martensite crystal grains is closer to 1, the shapes of the martensite crystal grains become closer to spherical shapes, with the result that the martensite crystal grains are less likely to become sources of stress concentration. Since the martensite crystal grains belonging to the first group (third group) and having relatively large crystal grains are less likely to become sources of stress concentration in quench-hardened layer 11 of inner ring 10, the wear resistance and toughness of quench-hardened layer 11 are further improved.

When the plurality of cementite grains are classified into the fifth group and the sixth group in quench-hardened layer 11 of inner ring 10, the average grain size of the cementite grains belonging to the fifth group and having relatively large grain sizes is less than or equal to 1.4 μm. When the plurality of cementite grains are classified into the seventh group and the eighth group in quench-hardened layer 11 of inner ring 10, the average grain size of the cementite grains belonging to the seventh group and having relatively large grain sizes is less than or equal to 1.10 μm. As the average grain size of the cementite grains is finer, the sizes of the martensite crystal grains are finer, thereby improving the toughness of quench-hardened layer 11. That is, in inner ring 10, even the cementite grains belonging to the fifth group (seventh group) and having relatively large crystal grains are fine, thus resulting in improved toughness of quench-hardened layer 11.

When the plurality of cementite grains are classified into the fifth group and the sixth group in quench-hardened layer 11 of inner ring 10, the number density of the cementite grains belonging to the fifth group and having relatively large grain sizes is more than or equal to 0.04 μm. When the plurality of cementite grains are classified into the seventh group and the eighth group in quench-hardened layer 11 of inner ring 10, the number density of the cementite grains belonging to the seventh group and having relatively large grain sizes is more than or equal to 0.06/μm². When the fine cementite grains are dispersed at a high density as described above, shear resistance of the surface is increased, thus resulting in improved wear resistance.

In the method for manufacturing the bearing part according to the embodiment, the primary tempering temperature is set to a temperature that is more than or equal to 200° C. and less than the A₁ transformation point in the primary tempering step of the performing the primary tempering onto the formed body having been through the primary quenching. From evaluation results described below, it was confirmed that when the primary tempering temperature is set to be more than or equal to 200° C., the maximum grain size of the martensite crystal grains in quench-hardened layer 11 is smaller, the maximum aspect ratio of the martensite crystal grains is lower, and the ratio of the maximum value to the minimum value of the crystal orientation density of the {011} planes of the martensite crystal grains is lower than those when the primary tempering temperature is set to less than 200° C. It was also confirmed that when the primary tempering temperature is set to be more than or equal to 200° C., the maximum grain size of the martensite crystal grains in quench-hardened layer 11, the maximum aspect ratio of the martensite crystal grains, and the ratio of the maximum value to the minimum value of the crystal orientation density of the {011} planes of the martensite crystal grains fall within the respective numerical ranges described above as compared with the case where the primary tempering temperature is set to be less than 200° C. Further, it was confirmed that when the primary tempering temperature is set to be more than or equal to 200° C., the indentation formation resistance is higher than that when the primary tempering temperature is set to be less than 200′C.

### EXAMPLES

The following describes a test performed to confirm the effect of the rolling part according to the second embodiment.

<Samples>

The present test was performed using samples 11 to 14 each processed into a shape of an outer ring of a rolling bearing. Steel used for each of samples 11 to 14 is SUJ2. Samples 11 to 14 were prepared by sequentially performing preparation step S1 to secondary tempering step S6 in accordance with the flowchart shown in FIG. 13 under conditions that only the primary tempering temperatures were different. In sample 11, the primary tempering temperature was set to 180° C. In sample 12, the primary tempering temperature was set to 200° C. In sample 13, the primary tempering temperature was set to 250° C. In sample 14, the primary tempering temperature was set to 400° C. It should be noted that the other manufacturing conditions were the same among samples 11 to 14, specifically, were set as follows. The first temperature in carbonitriding step S2 was set to 850° C., the second temperature in primary quenching step S3 was set to 830° C., the fourth temperature in secondary quenching step S5 was set to 810° C., and the secondary tempering temperature in secondary tempering step S6 was set to 180° C. The first period of time in primary tempering step S4 was set to 2 hours.

Samples 11 to 14 were evaluated as follows.

<Maximum Grain Size of Martensite Crystal Grains>

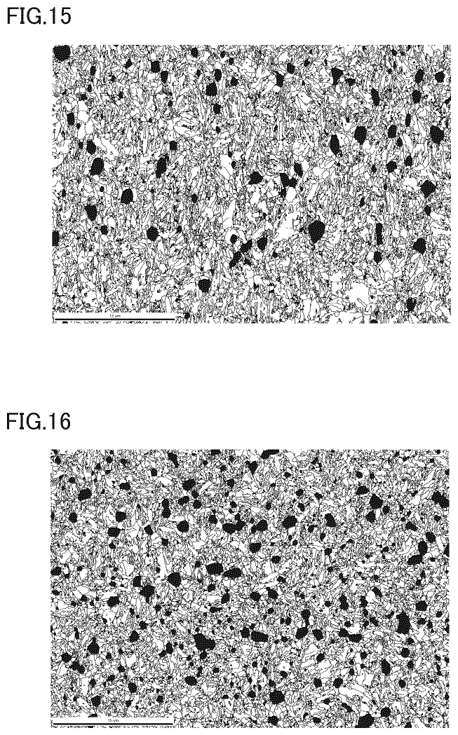

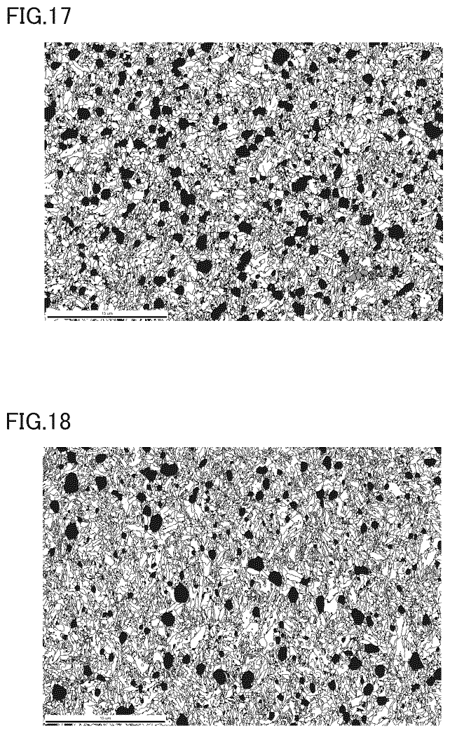

The maximum grain size of the martensite crystal grains of each of samples 11 to 14 was measured by the method described above. Each of FIGS. 15 to 18 shows an EBSD image at the raceway surface of each of samples 11 to 14.

The maximum grain size of the martensite crystal grains of sample 11 was 3.5 μm. On the other hand, the maximum grain size of the martensite crystal grains of sample 12 was 2.6 μm, the maximum grain size of the martensite crystal grains of sample 13 was 3.3 μm, and the maximum grain size of the martensite crystal grains of sample 14 was 3.1 μm. From this result, it was confirmed that in each of samples 12 to 4 for each of which the primary tempering temperature was set to be more than or equal to 200° C., the martensite crystal grains are finer than those in sample 11 for which the primary tempering temperature was set to be less than 200° C.

<Maximum Aspect Ratio of Martensite Crystal Grains>

The maximum aspect ratio of the martensite crystal grains of each of samples 11 to 14 was calculated by the above-described method. The maximum aspect ratio of the martensite crystal grains of sample 11 was 12.5. On the other hand, the maximum aspect ratio of the martensite crystal grains of sample 12 was 9.1, the maximum aspect ratio of the martensite crystal grains of sample 13 was 9.1, and the maximum aspect ratio of the martensite crystal grains of sample 14 was 10.0.

From this result, it was confirmed that the martensite crystal grains have spherical shapes in each of samples 12 to 4 for each of which the primary tempering temperature was set to be more than or equal to 200° C., as compared with sample 11 for which the primary tempering temperature was set to be less than 200° C.

<Ratio of Maximum Value to Minimum Value of Crystal Orientation Density of {011} Planes of Martensite Crystal Grains>

For each of samples 11 to 14, the ratio of the maximum value to the minimum value of the crystal orientation density of the {011} planes of the martensite crystal grains was calculated by the method described above. Calculation results are shown in Table 5. As shown in Table 5, the ratio in sample 11 was 5.3. On the other hand, the ratio in sample 12 was 3.6, the ratio in sample 13 was 3.5, and the ratio in sample 14 was 4.1.

TABLE 5

| | Crystal Orientation Density of {011} | | |
|---|---|---|---|
| | Planes of Martensite Crystal Grains | | |
| | Maximum Value | Minimum Value | Maximum Value/ |
| Samples | times random | times random | Minimum Value |
| Sample 11 | 1.7 | 0.3 | 5.3 |
| Sample 12 | 1.8 | 0.5 | 3.6 |
| Sample 13 | 1.8 | 0.5 | 3.5 |
| Sample 14 | 1.6 | 0.4 | 4.1 |

From this result, it was confirmed that the crystal orientations of the martensite crystal grains are uniform in each of samples 12 to 14 for each of which the primary tempering temperature was set to be more than or equal to 200° C. as compared with sample 11 for which the primary tempering temperature was set to be less than 200° C.

<Average Grain Size of Martensite Crystal Grains Belonging to First Group>

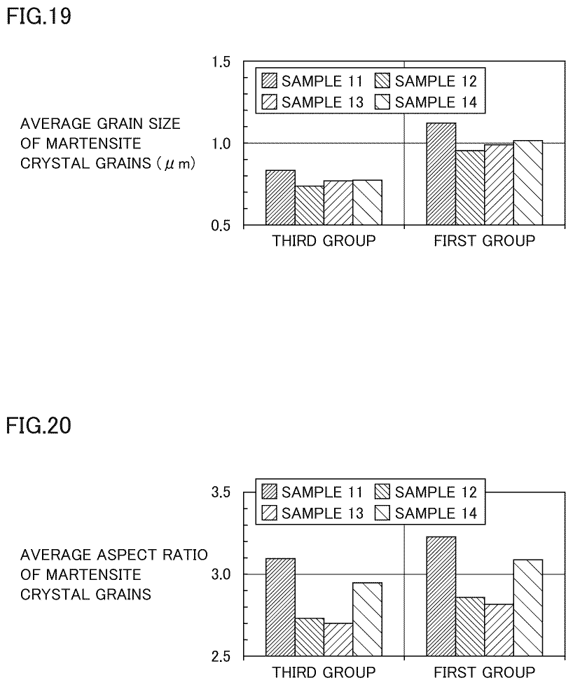

The average grain size of the martensite crystal grains belonging to the first group and the average grain size of the martensite crystal grains belonging to the third group were calculated for each of samples 11 to 14 by the method described above. FIG. 19 shows calculation results. The average grain size of the martensite crystal grains belonging to the first group in sample 11 was 1.12 pun, and the average grain size of the martensite crystal grains belonging to the third group in sample 11 was 0.83 μm.

On the other hand, the average grain size of the martensite crystal grains belonging to the first group in each of samples 12 to 14 was less than or equal to 1.10 μm, and the average grain size of the martensite crystal grains belonging to the first group was less than or equal to 1.00 μm in each of samples 12 and 13. The average grain size of the martensite crystal grains belonging to the first group in sample 12 was 0.95 μm. The average grain size of the martensite crystal grains belonging to the third group in each of samples 12 to 14 was less than or equal to 0.80 μm, and the average grain size of the martensite crystal grains belonging to the third group in each of samples 13 and 14 was 0.77 μm. The average grain size of the martensite crystal grains belonging to the third group in sample 12 was 0.74 μm.

From this result, it was confirmed that in each of samples 12 to 4 for each of which the primary tempering temperature was set to be more than or equal to 200° C., the martensite crystal grains were finer as a whole than those of sample 11 for which the primary tempering temperature was set to be less than 200° C.

<Average Aspect Ratio of Martensite Crystal Grains>

For each of samples 11 to 14, the average aspect ratio of the martensite crystal grains belonging to the first group and the average aspect ratio of the martensite crystal grains belonging to the third group were calculated by the method described above. FIG. 20 shows evaluation results. The average aspect ratio of the martensite crystal grains belonging to the first group in sample 11 was 3.23. On the other hand, the average aspect ratio of the martensite crystal grains belonging to the first group in sample 12 was 2.86, the average aspect ratio of the martensite crystal grains belonging to the first group in sample 13 was 2.82, and the average aspect ratio of the martensite crystal grains belonging to the first group in sample 14 was 3.09.

The average aspect ratio of the martensite crystal grains belonging to the third group in sample 11 was 3.09. On the other hand, the average aspect ratio of the martensite crystal grains belonging to the third group in sample 12 was 2.73, the average aspect ratio of the martensite crystal grains belonging to the first group in sample 13 was 2.70, and the average aspect ratio of the martensite crystal grains belonging to the first group in sample 14 was 2.95.

From the results, it was confirmed that in each of samples 12 to 4 for each of which the primary tempering temperature was set to be more than or equal to 200° C., the martensite crystal grains belonging to the first group (third group) and having relatively large grain sizes among the plurality of martensite crystal grains have spherical shapes as compared with sample 11 for which the primary tempering temperature was set to be less than 200° C.

<Average Grain Size of Cementite Grains>

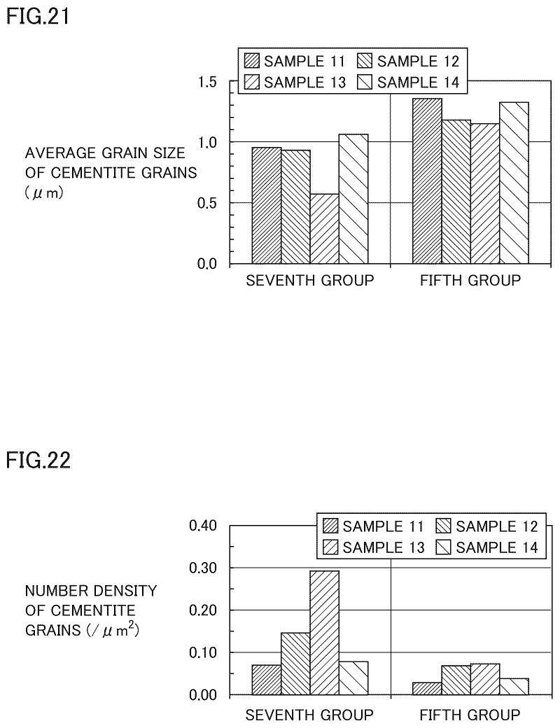

For each of samples 11 to 14, the average grain size of the cementite grains belonging to the fifth group and the average grain size of the cementite grains belonging to the seventh group were measured by the method described above. FIG. 21 shows calculation results. The average grain size of the cementite grains belonging to the fifth group in sample 11 was 1.35 μm, and the average grain size of the cementite grains belonging to the seventh group in sample 11 was 0.95 μm.

On the other hand, the average grain size of the cementite grains belonging to the fifth group in each of samples 12 to 14 was less than or equal to 1.32 μm, and the average grain size of the cementite grains belonging to the fifth group was less than or equal to 1.20 μm in each of samples 12 and 13. The average grain size of the cementite grains belonging to the fifth group in sample 13 was 1.15 μm.

The average grain size of the cementite grains belonging to the seventh group in each of samples 12 to 14 was less than or equal to 0.93 m, and the average grain size of the cementite grains belonging to the seventh group in sample 12 was 0.93 μm. The average grain size of the cementite grains belonging to the seventh group in sample 13 was 0.57 μm.

From the results, it was confirmed that in each of samples 12 and 3 for each of which the primary tempering temperature was set to be more than or equal to 200° C. and less than 400° C., the cementite grains belonging to the fifth group (seventh group) and having relatively large grain sizes among the plurality of cementite grains are finer than those in sample 11 for which the primary tempering temperature was set to be less than 200° C.

<Number Density of Cementite Grains>

The number density of the cementite grains belonging to the fifth group and the number density of the cementite grains belonging to the seventh group in each of samples 11 to 14 were measured by the method described above. FIG. 22 shows calculation results. The number density of the cementite grains belonging to the fifth group in sample 11 was 0.03/μm², and the number density of the cementite grains belonging to the seventh group in sample 11 was 0.07/μm².

On the other hand, the number density of the cementite grains belonging to the fifth group in each of samples 12 to 14 was more than or equal to 0.05/μm², and the number density of the cementite grains belonging to the fifth group in each of samples 12 and 13 was more than or equal to 0.07/μm².

The number density of the cementite grains belonging to the seventh group in each of samples 12 to 14 was more than or equal to 0.08/μm², and the number density of the cementite grains belonging to the seventh group in each of samples 12 and 13 was more than or equal to 0.10/μm². The average grain size of the cementite grains belonging to the seventh group in sample 13 was 0.29/μm².

From the results, it was confirmed that in each of samples 12 to 4 for each of which the primary tempering temperature was set to be more than or equal to 200° C., the cementite grains belonging to the fifth group (seventh group) and having relatively large grain sizes among the plurality of cementite grains were dispersed at a higher density than in sample 11 for which the primary tempering temperature was set to be less than 200° C.

<Average Nitrogen Concentration of Quench-Hardened Layer>

For each of samples 11 to 14, the average nitrogen concentration of the quench-hardened layer was measured by the above-described method at a position at a distance of 10 μm from the raceway surface. The average nitrogen concentration in each of samples 11 to 14 was more than or equal to 0.10 mass %. The average nitrogen concentration of each of samples 11, 12, and 14 was more than or equal to 0.13 mass %

<Remaining Austenite Amount in Raceway Surface>

A remaining austenite amount γ in each of the raceway surfaces of samples 11 to 14 was measured by the method described above. Remaining austenite amount 7 in each of the raceway surfaces of samples 11 to 14 was more than or equal to 20 volume %. Remaining austenite amount γ in each of the raceway surfaces of samples 13 and 14 was 24 volume %.

<Hardness of Raceway Surface>

For each of samples 11 to 14, compressive residual stress in the raceway surface was measured by the method described above. The hardness of each of the raceway surfaces in samples 11 to 14 was more than or equal to 700 HV. The hardness of each of the raceway surfaces in samples 11 to 14 was more than or equal to 780 HV. The hardness of each of the raceway surfaces in samples 12 and 13 was harder than the hardness of the raceway surface in sample 11. The hardness of each of the raceway surfaces in samples 12 and 13 was more than or equal to 790 HV.

<Average Grain Size of Prior Austenite Grains in Raceway Surface>

For each of samples 11 to 14, the prior austenite grains in the raceway surface were measured by the method described above. The average grain size of the prior austenite grains in sample 11 was 3.8 μm. On the other hand, the average grain size of the prior austenite grains in sample 12 was 3.4 μm, the average grain size of the prior austenite grains in sample 13 was 3.5 μm, and the average grain size of the prior austenite grains in sample 14 was 3.4 m.

From this result, it was confirmed that in each of samples 12 to 4 for each of which the primary tempering temperature was set to be more than or equal to 200° C., the prior austenite grains in the raceway surface are finer than those in sample 11 for which the primary tempering temperature was set to be less than 200° C. In other words, in each of samples 12 to 14, it was confirmed that the austenite crystals having existed in the steel having been heated to the quenching temperature in the secondary quenching step and just before the quenching are finer than those in sample 11.

<Compressive Residual Stress in Raceway Surface>

Compressive residual stress in each of the raceway surfaces in samples 11 to 14 was measured by the method described above. The compressive residual stress in each of the raceway surfaces in samples 11 to 14 was more than or equal to 100 MPa. The compressive residual stress in each of the raceway surfaces in samples 13 and 14 was more than or equal to 130 MPa. The compressive residual stress in the raceway surface in sample 13 was more than or equal to 140 MPa.

From the above evaluation results, it was confirmed that fine martensite crystal grains are formed more uniformly and fine cementite grains are dispersed at a higher density in each of samples 12 to 14 than in sample 11. In view of this, it can be said that the shear resistance of each of the quench-hardened layers of samples 12 to 14 is higher than the shear resistance of the quench-hardened layer of sample 11. It is considered that as the shear resistance is higher, the surface is more activated in response to an increase in temperature due to the shear, with the result that a large amount of gas is adsorbed on the surface. Therefore, when shear stress is applied in parallel with the raceway surface within each of the quench-hardened layers, it is considered that the wear resistance of the raceway surface is improved in each of samples 12 to 14 as compared with sample 11 because the raceway surface is activated in response to the increase in temperature due to the shear

<Indentation Formation Resistance of Raceway Surface>

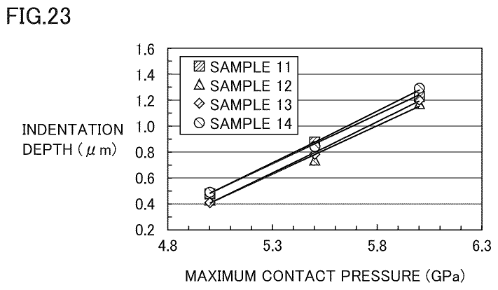

The indentation formation resistance of the raceway surface in each of samples 11 to 14 was evaluated as follows. First, a ceramic ball composed of silicon nitride and having a diameter of ⅜ inch was pressed against the raceway surface in each of samples 11 to 14 under a maximum pressing load for 120 seconds, and then the load was removed, thereby forming an indentation. The maximum pressing load was set as three different conditions. In other words, three indentations were formed in the raceway surface of each sample. Second, the depth of each indentation was measured to find a relation between the maximum contact pressure and the indentation depth. It should be noted that the maximum contact pressure is defined as a value obtained by dividing each maximum pressing load by an area of projection of each indentation (contact area between the raceway surface and the ceramic ball). FIG. 23 shows evaluation results.

Each of the indentation depths of samples 12 and 13 was shallower than each of the indentation depths of samples 11 and 14. That is, the indentation formation resistance of each of the raceway surfaces in samples 12 and 13 was higher than the indentation formation resistance in each of samples 11 and 14. The indentation depth in sample 14 was substantially comparable to the indentation depth of sample 11.

From the above evaluation results, it was confirmed that the surface damage resistance and toughness of each of the raceway surfaces in samples 12 to 14 are improved as compared with sample 11.

Although the embodiments of the present invention have been illustrated, the embodiments described above can be modified in various manners. Further, the scope of the present invention is not limited to the above-described embodiments. The scope of the present invention is defined by the terms of the claims, and is intended to include any modifications within the scope and meaning equivalent to the terms of the claims.

### INDUSTRIAL APPLICABILITY

Each of the above-described embodiments is applied particularly advantageously to a bearing part and a rolling bearing employing the bearing part.

### REFERENCE SIGNS LIST

10: inner ring; 10a: upper surface, 10b. bottom surface, 10c: inner circumferential surface, 10d: outer circumferential surface; 10e: center axis; 11: quench-hardened layer; S1: preparing step; S2: carbonitriding step; S3: first tempering step; S4: quenching step; S5: second tempering step; S6: post-process step.

1. A bearing part composed of a steel, the bearing part comprising a quench-hardened layer in a surface of the bearing part, wherein
the quench-hardened layer includes a plurality of martensite crystal grains,
a ratio of a total area of the plurality of martensite crystal grains in the quench-hardened layer is more than or equal to 70%,
the plurality of martensite crystal grains are classified into a first group and a second group,
a minimum value of crystal grain sizes of the martensite crystal grains belonging to the first group is larger than a maximum value of crystal grain sizes of the martensite crystal grains belonging to the second group,
a value obtained by dividing a total area of the martensite crystal grains belonging to the first group by the total area of the plurality of martensite crystal grains is more than or equal to 0.3,
a value obtained by dividing, by the total area of the plurality of martensite crystal grains, a total area of the martensite crystal grains belonging to the first group except for a martensite crystal grain that has a minimum crystal grain size and that belongs to the first group is less than 0.3,
an average grain size of the martensite crystal grains belonging to the first group is less than or equal to 1.5 μm,
the quench-hardened layer further includes a plurality of cementite grains, and
a number density of cementite grains each having a grain size of more than or equal to 1 μm is more than or equal to 0.025/μm².

2. The bearing part according to claim 1, wherein an average aspect ratio of the martensite crystal grains belonging to the first group is less than or equal to 3.1.

3. The bearing part according to claim 1, wherein
the quench-hardened layer contains nitrogen, and
an average nitrogen concentration of the quench-hardened layer is more than or equal to 0.15 mass % between the surface and a position at a distance of 10 μm from the surface.

4. The bearing part according to claim 1, wherein a remaining austenite amount in the surface is more than or equal to 20 volume %.

5. The bearing part according to claim 1, wherein a hardness of the quench-hardened layer in the surface is more than or equal to 730 Hv.

6. The bearing part according to claim 1, wherein the steel is a high carbon chromium bearing steel SUJ2 defined in JIS.

7. A rolling bearing comprising an outer ring, an inner ring, and a rolling element, wherein
at least one of the outer ring, the inner ring, and the rolling element is the bearing part according to claim 1.

8. The bearing part according to claim 2, wherein
the quench-hardened layer contains nitrogen, and
an average nitrogen concentration of the quench-hardened layer is more than or equal to 0.15 mass % between the surface and a position at a distance of 10 μm from the surface.

9. The bearing part according to claim 2, wherein a remaining austenite amount in the surface is more than or equal to 20 volume %.

10. The bearing part according to claim 3, wherein a remaining austenite amount in the surface is more than or equal to 20 volume %.

11. The bearing part according to claim 8, wherein a remaining austenite amount in the surface is more than or equal to 20 volume %.

12. The bearing part according to claim 2, wherein a hardness of the quench-hardened layer in the surface is more than or equal to 730 Hv.

13. The bearing part according to claim 3, wherein a hardness of the quench-hardened layer in the surface is more than or equal to 730 Hv.

14. The bearing part according to claim 8, wherein a hardness of the quench-hardened layer in the surface is more than or equal to 730 Hv.

15. The bearing part according to claim 4, wherein a hardness of the quench-hardened layer in the surface is more than or equal to 730 Hv.

16. The bearing part according to claim 9, wherein a hardness of the quench-hardened layer in the surface is more than or equal to 730 Hv.

17. The bearing part according to claim 10, wherein a hardness of the quench-hardened layer in the surface is more than or equal to 730 Hv.

18. The bearing part according to claim 11, wherein a hardness of the quench-hardened layer in the surface is more than or equal to 730 Hv.

19. The bearing part according to claim 2, wherein the steel is a high carbon chromium bearing steel SUJ2 defined in JIS.

20. The bearing part according to claim 3, wherein the steel is a high carbon chromium bearing steel SUJ2 defined in JIS.
